(19) United States
(12) Patent Application Publication
(10) Pub. No.: US 2012/0228555 A1
(43) Pub. Date: Sep. 13, 2012

(54) METHOD FOR MAKING GRAPHENE

(75) Inventors: I. Francis Cheng, Moscow, ID (US); David N. McIlroy, Moscow, ID (US); Jeremy Foutch, Moscow, ID (US); Peter R. Griffiths, Moscow, ID (US)

(73) Assignee: University of Idaho

(21) Appl. No.: 13/366,022

(22) Filed: Feb. 3, 2012

Related U.S. Application Data
(63) Continuation-in-part of application No. PCT/US2010/044269, filed on Aug. 3, 2010.
(60) Provisional application No. 61/230,958, filed on Aug. 3, 2009.
(60) Provisional application No. 61/253,334, filed on Oct. 20, 2009.
(60) Provisional application No. 61/259,734, filed on Nov. 10, 2009.

(51) Int. Cl. H01B 1/04; C01B 31/02; B82Y 30/00; B82Y 40/00

(52) U.S. Cl. 252/503; 423/448; 252/502; 252/508; 977/734; 977/842; 977/890; 977/762

(57) ABSTRACT

Particular embodiments of the current method disclose a method for making graphene, comprising providing a starting material and heating the starting material for a time and to a temperature effective to produce graphene. Certain embodiments utilize starting materials comprising carbonaceous materials used in conjunction with, or comprising, sulfur, and essentially free of a transition metal. The graphene produced by the current method can be used to coat graphene-coatable materials.

### CROSS REFERENCE TO RELATED APPLICATION

This application is a continuation-in-part under 35 U.S.C. §120 of PCT/US2010/044269, filed on Aug. 3, 2010, which claims the benefit of the earlier filing date of U.S. Provisional Application No. 61/230,958, filed Aug. 3, 2009, U.S. Provisional Application No. 61/253,334, filed Oct. 20, 2009, and U.S. Provisional Application No. 61/259,734, filed Nov. 10, 2009. Each of these prior applications is incorporated herein by reference in their entirety.

### FIELD

The present disclosure concerns a method for making graphene.

### BACKGROUND

The discovery of fullerene has sparked an increased interest in the production of graphene, and exploitation of its various physicochemical properties. Methods for producing graphene particles and materials have been developed and their use in applications, such as nanotube production and use in electrodes and circuits are being explored. Several features of graphene make it a unique substance. For instance, graphene can sustain current densities six orders of magnitude higher than metals, like copper, it is thermally conductive, impermeable to gases and ductile.

Graphene comprises a planar sheet of sp²-bonded carbon atoms, which are packed in a particular lattice formation. Methods for making graphene have been reported. Such methods include the following: (1) using a drawing method, whereby graphene is obtained by mechanical exfoliation of graphite; (2) epitaxial growth on metal substrates, whereby the atomic structure of a metal substrate is used to seed the growth of graphene; (3) hydrazine reduction, whereby graphene oxide paper is added to a solution of pure hydrazine, which reduces the graphene oxide to graphene; and (6) producing graphene ribbons from cutting open nanotubes. Currently, there are drawbacks with these methods, such as the high cost of large scale transformations, the small size of substrates used for epitaxial growth, and the time-consuming and delicate nature of the drawing method.

Graphene has utility in many practical applications, such as use in the production of membranes for sensing pressure and chemicals, and as components in nanoelectromechanical systems. Due to its unique thinness, graphene can be used to make transistors that run at higher frequencies and more efficiently than currently-used silicon transistors. The electronic properties of graphene can be influenced by gas molecules, allowing it to act as a chemical sensor. Graphene can also potentially be used as a thin protective coating in order to protect against agents, such as acids and alkalis, because of its resistance to these agents. Additional applications of graphene materials include usage in lithium ion batteries, supercapacitors, and catalyst supports.

U.S. Patent Publication No. 2006/0062715 discloses the formation of an ultra thin carbon fiber having two or more graphene sheets layered using a mixture of raw material organic compound, iron, cobalt, molybdenum, ferrocene, or metal acetate, and sulfur (or thiophene or ferric sulfide) as a catalyst. This publication teaches the need for a transition metal and temperatures ranging from 800° C. to 1300° C., and/or temperatures ranging from 2400° C. to 3000° C.

U.S. Pat. No. 7,442,358 discloses the formation of stacks of graphene sheets. One example included the use of toluene as a starting material, ferrocene as a primary catalyst, dodecanthiol as a co-catalyst and carbon dioxide as a medium. These components were reacted at 430° C. and a pressure of 25 MPa for three hours. The product was then calcined and used to make a lithium secondary battery.

Despite the advances in graphene synthesis, there still exists a need for methods which can provide large scale production of graphene cost effectively.

### SUMMARY

Disclosed herein are embodiments of a method for making graphene, comprising a starting material (or plurality of starting materials) that does not include a transition metal (e.g. is essentially free of a transition metal), such as a carbonaceous material to which sulfur is affirmatively added, or a carbonaceous material comprising sulfur. The starting material, or plurality of starting materials, is heated to a temperature and for a time effective to produce graphene.

Particular embodiments utilize a starting material comprising a carbonaceous material that does not inherently contain sulfur, but to which sulfur is affirmatively added. Certain embodiments utilize hydrocarbons as carbonaceous material. Hydrocarbons can be selected from aliphatic and aromatic hydrocarbons. In addition, heteroaliphatic and heteroaromatic compounds can be used. Particular embodiments utilize carbonaceous material that comprises saturated, acyclic aliphatic compounds and/or heteroaliphatic compounds having from about 8 carbon atoms to about 40 carbon atoms. Other embodiments utilize carbonaceous material that comprises unsaturated, cyclic aliphatic and/or heterocyclic compounds having from about 3 carbon atoms to about 12 carbon atoms in a ring. Examples of carbonaceous materials include, but are not limited to paraffin, motor oil, mineral oil, and organic compounds, such as hexanes, cyclohexanol, ethyl alcohol, propanol, hexanol, phenol, toluene, fluoranthene, pyrene, naphthalene, anthracene, tetracene, pentacene, phenanthrene, and triphenylene.

Certain embodiments utilize a starting material, or plurality of starting materials, comprising a carbonaceous material which inherently contains sulfur. Particular embodiments utilize tars obtained from petroleum distillates, such as, but not limited to, asphalt, roofing tar, bitumen, and kerogen. Other embodiments include using carbohydrates as carbonaceous materials.

Embodiments of the current method utilize a separate source of sulfur other than carbonaceous materials comprising sulfur, which can be affirmatively added to carbonaceous materials that do not inherently contain sulfur. Sources of sulfur can be a sulfur-containing material or elemental sulfur. Examples of sulfur-containing material include, but are not limited to, thiols, sulfides, disulfides, sulfones, and sulfonyls. Particular embodiments utilize dimethylsulfoxide (DMSO), sulfosalicylic acid, thiophenol, and octanethiol. In particular embodiments, the elemental sulfur or sulfur-containing material is affirmatively added in an effective amount necessary to convert the starting material to graphene. A person of ordinary skill in the art will appreciate that, in commercial embodiments, the amount of sulfur used will typically depend on the amount of starting material used; however, the working embodiments of the current method typically use an effective amount of sulfur ranging from greater than 0 to about 100 grams of sulfur. Particular embodiments utilize a range of greater than 0.05 grams to about 10 grams of sulfur; more typically, from about 0.1 grams to about 5 grams of sulfur is used. Affirmative addition of sulfur-containing material and/or elemental sulfur can occur at any point before the formation of graphene. In other particular embodiments, the sulfur reagent and/or elemental sulfur is inherently present in the carbonaceous material.

Embodiments of the current method heat the starting material (or plurality of starting materials) to a temperature effective to produce graphene. A temperature effective to produce graphene includes heating to, or above, the pyrolysis temperature of the carbonaceous material. The temperature effective to produce graphene and/or to cause pyrolysis of the carbonaceous material depends on the starting material, but typically ranges from about 250° C. to about 1200° C.; more typically, the temperature ranges from at least about 600° C. to about 1000° C. Certain embodiments utilize temperatures ranging from about 700° C. to about 1000° C. Heating continues for a time effective to produce graphene. Particular embodiments of the current method can be heated for a time period, ranging from greater than 0 to about 60 minutes; more typically from about 2 minutes to about 20 minutes; and even more typically, from about 5 minutes to about 10 minutes.

Particular embodiments disclose a method for making graphene, comprising heating oil shale to a temperature and for a time effective to produce graphene. Certain embodiments also disclose a composition where the starting material consists essentially of a carbonaceous material and sulfur.

Certain embodiments illustrate a method for using graphene, comprising heating the starting material (or plurality of starting materials) to a temperature and for a time effective to produce graphene in the presence of a graphene-coatable material or a device having a graphene-coatable surface. Particular embodiments do not require the addition of a transition metal and use conditions that are essentially free of a transition metal. Exemplary embodiments of graphene-coatable surfaces include, but are not limited to, nanosprings, nanotubes, diatomites, a metal (such as copper or iron), glass, mica, germanium, and silicon.

The foregoing and other objects, features, and advantages of the invention will become more apparent from the following detailed description, which proceeds with reference to the accompanying figures.

### BRIEF DESCRIPTION OF THE DRAWINGS

FIG. 1 is a schematic diagram of a current theory of operation for the disclosed method of making graphene.

FIG. 2 is a digital image of the results from the current method utilizing paraffin and 3.5 grams (2), 2.0 grams (4), and 0.5 grams (6) of sulfur.

FIG. 3 is a digital image of the results from the current method utilizing motor oil and 5.0 grams (10), 2.0 grams (12), 1.0 grams (14), 0.10 grams (18) of sulfur, as well as no sulfur (16).

FIG. 4 is a digital image of the results from the current method utilizing mineral oil and with 5.0 grams (20), 2.0 grams (22), 1.0 grams (24), 0.10 grams (28) of sulfur, as well as no sulfur (26).

FIG. 5 is a digital image of the results from the current method utilizing cyclohexanol and 5.0 grams sulfur (30), as well as no sulfur (32).

FIG. 6 is a diagram illustrating a closed system, which is utilized in particular embodiments of the disclosed method.

FIG. 7 is a digital image of an outer crucible containing graphene produced from roofing cement.

FIG. 8 is an optical image from a microscope illustrating an exfoliated sample of graphene obtained using certain embodiments of the disclosed method.

FIG. 9 is an optical image from a microscope of exfoliated graphene obtained from the use of motor oil and 5.0 grams of sulfur.

FIG. 10 is an optical image from a microscope of exfoliated flakes of graphene obtained from experiments utilizing mineral oil and 3.5 grams of sulfur.

FIG. 11 is a spectrum obtained from Raman analysis of a graphene sample produced using the current method.

FIG. 12 is a spectrum obtained from Fourier transform-infrared spectroscopic analysis (FT-IR) of graphene on a germanium disk.

FIG. 13 is a spectrum obtained from x-ray photoelectron spectroscopic (XPS) analysis of a graphene sample obtained from particular embodiments of the disclosed method.

FIG. 14 is a spectrum obtained from x-ray photoelectron spectroscopic (XPS) analysis of a graphene sample obtained from particular embodiments of the disclosed method, illustrating the valence band region.

FIG. 15 is a XPS spectrum of the C is core level state of graphene.

FIG. 16 is a 2-dimensional image illustrating the atomic structure of graphene made by the current method.

FIG. 17 is a micrograph (0.7×0.7 nm 3D) of graphene obtained from a particular embodiment of the current method.

FIG. 18 is an image illustrating line analysis of topography showing the periodicity of atomic structure of graphene.

FIG. 19 is an image produced by a scanning electron microscope (SEM) illustrating graphene flakes produced using one embodiment of the current method.

FIG. 20 is an image produced by a scanning electron microscope (SEM) illustrating an edge of graphene produced using one embodiment of the current method.

FIG. 21 is a digital image illustrating an approximately 25 mm diameter graphene flake produced in one embodiment of the current method.

FIG. 22 is a thermogram of percent weight loss (Y-axis) versus temperature in degrees Celsius (X-axis).

FIG. 23 is an image produced by a scanning electron microscope (SEM) illustrating layers of graphene produced using one embodiment of the current method.

FIG. 24 is an image produced by a scanning electron microscope (SEM) illustrating diatoms coated with graphene using one embodiment of the current method.

FIG. 25 is an image produced by a scanning electron microscope (SEM) illustrating uncoated diatoms.

FIG. 26 is an optical image of large graphene sheets floating on the surface of water.

FIG. 27 is an SEM image of a graphene flake on top of a copper grid.

FIG. 28 is a TEM image of graphene film, illustrating layers.

FIG. 29 is a 3D AFM image of graphene.

FIG. 30 is a 2D AFM image of graphene for an 8 μm×8 μm scanning area.

FIG. 31 is an image illustrating the height profile of a particular graphene sample.

FIG. 32 is a Raman spectrum obtained from thermogravimetric analysis, illustrating the peak obtained at 600° C.

FIG. 33 is a Raman spectrum obtained from thermogravimetric analysis, illustrating the peak obtained at 400° C.

FIG. 34 is a Raman spectrum obtained from thermogravimetric analysis, illustrating the peak obtained at 550° C.

### DETAILED DESCRIPTION

### I. Terms

Aliphatic: Any open or closed chain molecule, excluding aromatic compounds, containing only carbon and hydrogen atoms which are joined by single bonds (alkanes), double bonds (alkenes), or triple bonds (alkynes). This term encompasses substituted aliphatic compounds, saturated aliphatic compounds, and unsaturated aliphatic compounds.

Alkane: Chemical compounds comprising only of the elements carbon and hydrogen, wherein these atoms are linked together exclusively by single bonds (i.e., they are saturated compounds).

Aromatic: A term describing conjugated rings having unsaturated bonds, lone pairs, or empty orbitals, which exhibit a stabilization stronger than would be expected by the stabilization of conjugation alone. It can also be considered a manifestation of cyclic delocalization and of resonance.

Carbonaceous: The defining attribute of a substance rich in carbon.

Carbonaceous hydrocarbons can be unsaturated, high-molecular-weight hydrocarbons, having an elevated carbon:hydrogen ratio, or saturated hydrocarbons.

Coatable material: A material that is capable of being covered with graphene using the disclosed method.

Cyclic: Designates a substantially hydrocarbon, closed-ring compound, or a radical thereof. Cyclic compounds or substituents also can include one or more sites of unsaturation, but does not include aromatic compounds. One example of such a cyclic compound is cyclopentadieneone.

Disulfide: A term used to describe compounds which are composed of a linked pair of sulfur atoms and which can be bound to other functional groups.

Functional Group: A specific group of atoms within a molecule that is responsible for the characteristic chemical reactions of those molecules. The same functional group will undergo the same or similar chemical reaction(s) regardless of the size of the molecule it is a part of Examples include, but are not limited to, alcohols, alkenes, alkynes, thiols, disulfides, sulfides, sulfonyls, sulfoxides, and carbonyl groups.

Graphene: Individual layers of graphite in which each carbon atom is bonded to three other carbon atoms. Typically, “graphene” can be a planar sheet of sp²-bonded carbon atoms that are densely packed in a honeycomb crystal lattice. As used herein, “graphene” can be used to denote monolayered and/or multilayered forms of graphene.

Heteroaliphatic: An aliphatic group, which contains one or more atoms other than carbon and hydrogen, such as, but not limited to, oxygen, sulfur, nitrogen, phosphorus, chlorine, fluorine, bromine, iodine, and selenium.

Heterocycle: Cyclic compounds with at least two different elements as ring members atoms.

Hydrocarbon: An organic compound consisting entirely of carbon and hydrogen.

Isomeric: “Isomeric” is used to describe an isomer, which is a compound with the same molecular formula as another compound but with different a structural formula.

Precursor: A compound that participates in the chemical reaction that produces another compound.

Polycyclic: A cyclic compound with more than one ring structure. This term generally includes all aromatic and alkane hydrocarbons having more than one ring.

Sulfide: A moiety represented by the formula —SR, wherein R can be an alkyl group, optionally substituted with an alkenyl, alkynyl, aryl, arylakyl, cycloalkyl, halogenated alkyl, or heterocycloalkyl group as described above. The term sulfhydryl is used to refer to the formula —SR wherein R is H.

Thiol: A compound that contains the functional group composed of a sulfur-hydrogen bond (—SH). Being the sulfur analogue of an alcohol group (—OH), this functional group is referred to as either a thiol group or a sulfhydryl group. In the more traditional sense, thiols are often referred to as mercaptans.

Transition Metal: Any of the metallic elements within Groups 3 to 12 in the Periodic Table that have an incomplete inner electron shell and that serve as transitional links between the most and the least electropositive in a series of elements.

### II. Introduction

Disclosed embodiments describe a method for making graphene using a carbonaceous starting material and sulfur, comprising heating the carbonaceous material and sulfur to a temperature and for a time effective to produce graphene. In particular embodiments, the carbonaceous starting material does not inherently comprise sulfur but is used in conjunction with a separate source of sulfur. In other embodiments, the carbonaceous starting material inherently comprises sulfur.

The carbonaceous starting material, which either contains sulfur or is used in conjunction with a separate source of sulfur, is added to a first container. The first container can be used alone, or can be placed inside a second container. The second container and/or first container holding the carbonaceous starting material and sulfur is then maintained under a partially or completely inert atmosphere by methods known to a person of ordinary skill in the art to include covering the system, placing the system under an atmosphere of inert gas, or placing the system under pressure. The system containing the starting materials is heated to a temperature effective to produce graphene using a heat source. Heating is carried out for a time effective to produce graphene, typically from about greater than 0 to about 60 minutes; more typically from about 2 minutes to about 20 minutes. In disclosed embodiments the reaction vessel, which contains the carbonaceous starting material and sulfur, is heated for a range of time from about 5 minutes to about 8 or 10 minutes. Certain embodiments employ a cooling period ranging in time from about greater than 0 to about 60 minutes, more typically from about 4 minutes to about 10 minutes. A person of ordinary skill in the art will understand that the temperature and time effective to produce graphene may depend on the amount of starting material used.

Embodiments of the current method can be used to at least partially or fully coat materials or devices containing surfaces capable of being coated with graphene.

### III. Method for Making Graphene

A. Starting Materials

Certain embodiments disclosed herein utilize starting materials that can either inherently contain sulfur or only need be reacted with sulfur in order to form graphene. Working embodiments of the current method do not utilize a transition metal catalyst (or additive) (e.g. are essentially free of a transition metal catalyst) to form graphene. Starting materials that do not inherently contain sulfur can be utilized. These starting materials can be selected from carbonaceous materials, including, but not limited to, aliphatic hydrocarbons, aromatic hydrocarbons, substances that contain one or more of these classes of hydrocarbons, heteroaliphatic compounds, heteroaromatic compounds, and combinations thereof. Certain embodiments utilize saturated or unsaturated acyclic hydrocarbons, saturated or unsaturated cyclic hydrocarbons, saturated or unsaturated polycyclic hydrocarbons, and saturated or unsaturated oxygen-containing starting materials.

Examples of aliphatic hydrocarbons include any hydrocarbon known to a person of ordinary skill in the art to have a formula CₙH₂ₙ₊₂, Particular embodiments use saturated, acyclic aliphatic hydrocarbons having 1 carbon atom to about 40 carbon atoms, more typically saturated, acyclic aliphatic hydrocarbons having from about 8 carbon atoms to about 40 carbon atoms. Certain embodiments employ starting materials comprising monocyclic hydrocarbons. These starting materials have a general formula CₙH₂ₙ, and can have 3 carbon atoms to about 12 carbon atoms. Particular embodiments utilize monocyclic hydrocarbons having from about 3 carbon atoms to about 12 carbon atoms in a ring. A person of ordinary skill in the art will recognize that polycyclic hydrocarbons, as well as unsaturated acyclic, cyclic, and polycyclic hydrocarbons, can also be utilized in the current method.

Aromatic hydrocarbons can also be utilized as starting materials suitable for making graphene. Certain embodiments utilize monocyclic aromatic hydrocarbons, such as, but not limited to, benzene, toluene, and xylene. Particular embodiments utilize polycyclic aromatic hydrocarbons, including aromatic hydrocarbons having from about one aromatic ring to about 6 aromatic rings fused or linked together. Exemplary embodiments include naphthalene, anthracene, tetracene, fluoranthene, pyrene, and pentacene. In addition, isomeric polyaromatic hydrocarbons can be used in the disclosed method, such as phenanthrene and triphenylene.

Embodiments of the disclosed method also include using heteroaliphatic compounds. Particular embodiments utilize oxygen-containing carbonaceous materials. These carbonaceous materials can include acyclic and/or cyclic alcohols. Exemplary acyclic alcohols include compounds having from about 1 carbon atom and at least one oxygen atom to about 40 carbon atoms and at least one oxygen atom. Certain embodiments can employ monocyclic alcohols having 3 carbon atoms to about 12 carbon atoms. Particular embodiments utilize cyclic compounds having from about 3 carbon atoms and at least one oxygen atom to about 12 carbon atoms and at least one oxygen atom. A person of ordinary skill in the art will also recognize that polycyclic heteroaliphatic compounds can be used in the current method, as well as any unsaturated form of acyclic, cyclic, or polycyclic heteroaliphatic compounds. Exemplary embodiments disclose the use of cyclohexanol, phenol, ethyl alcohol, propanol (e.g. 2-propanol), and hexanol (e.g. 1-hexanol) as a starting material.

Starting materials that do not inherently contain sulfur can be used in the current method. Typically, embodiments utilizing starting materials that do not inherently contain sulfur require affirmative addition of sulfur. In other embodiments, starting materials inherently comprising sulfur are utilized. The forms of sulfur used in disclosed embodiments are discussed below.

B. Sulfur Reagents

Embodiments of the disclosed method utilize sulfur as a reagent for forming graphene. Sulfur can be independent from the carbonaceous material or the starting material can comprise sulfur. Particular embodiments that utilize the addition of sulfur to the carbonaceous material can utilize any form of sulfur known to a person of ordinary skill in the art to promote the conversion of the starting material to graphene. Exemplary embodiments utilize the addition of elemental sulfur, or a sulfur-containing material, such as dimethylsulfoxide (DMSO), and sulfosalicylic acid. A person of ordinary skill in the art will recognize that any sulfur-containing materials, such as thiols, sulfides, and disulfides can be employed in the current method. Exemplary embodiments concern using thiophenol and 1-octanethiol.

Other embodiments utilize carbonaceous materials that comprise sulfur. A person of ordinary skill in the art will recognize that a carbonaceous material comprising sulfur may not require the addition of a separate source of sulfur. These embodiments include tars containing carbonaceous materials and sulfur, such as tar from petroleum distillates. Particular embodiments utilize asphalt, bitumen, and kerogen. These starting materials inherently contain an amount of sulfur effective for producing graphene. Typically, these starting materials contain more than 0 percent to about 50 percent sulfur; even more typically, they contain from about 0.5 percent to about 5 percent sulfur.

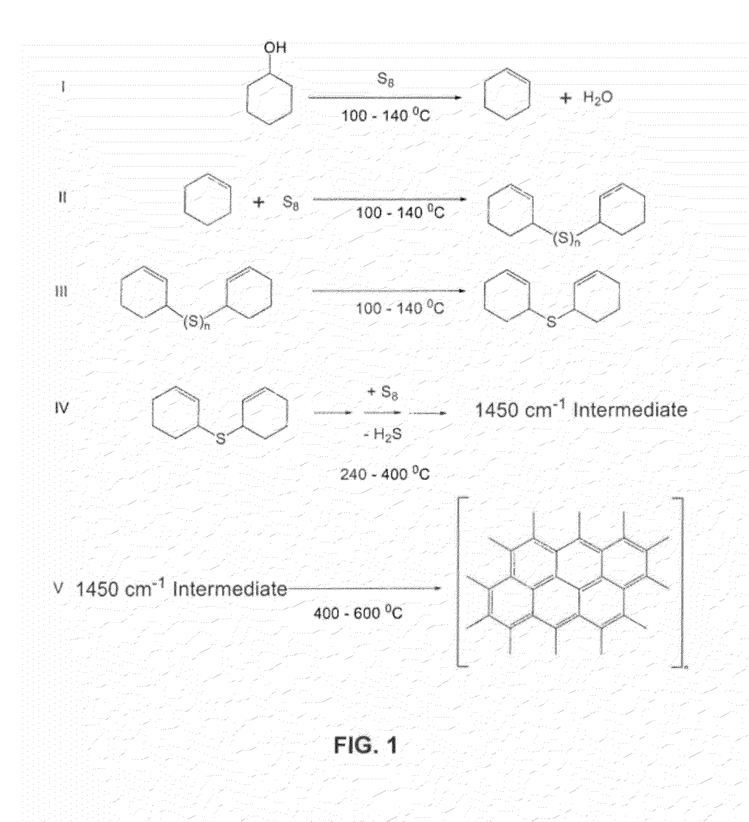

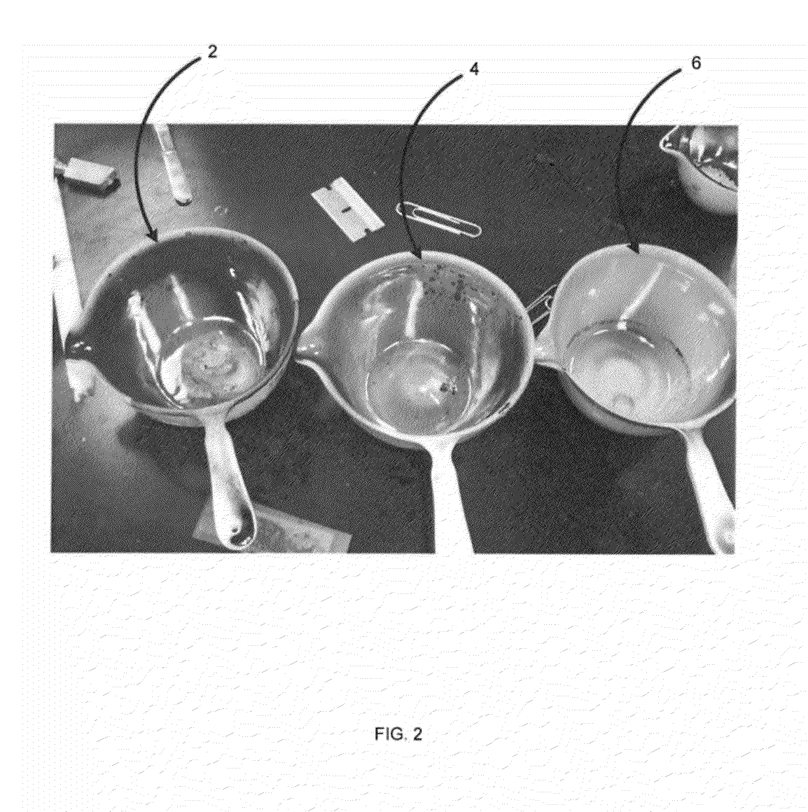

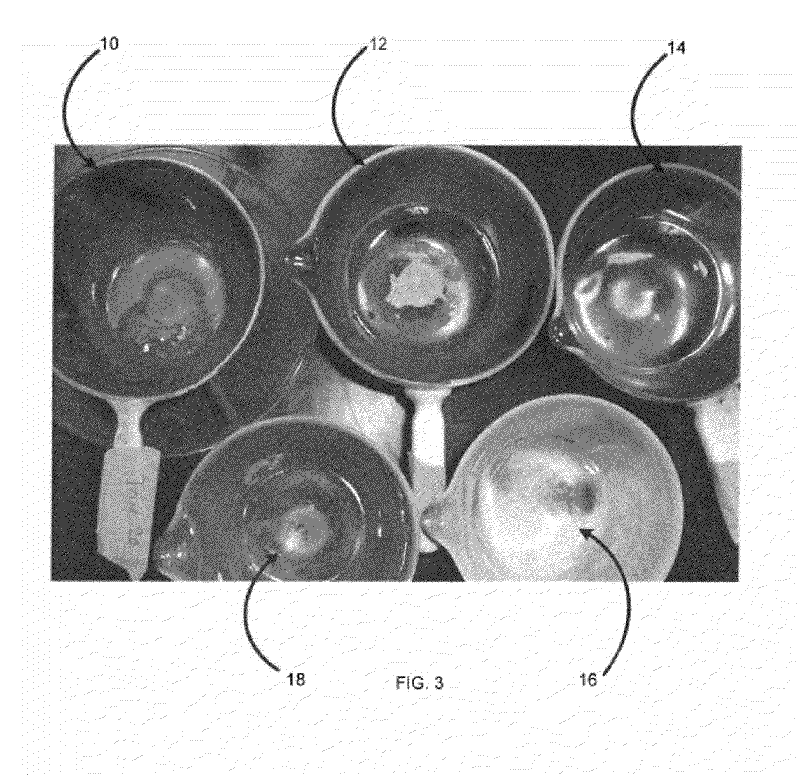

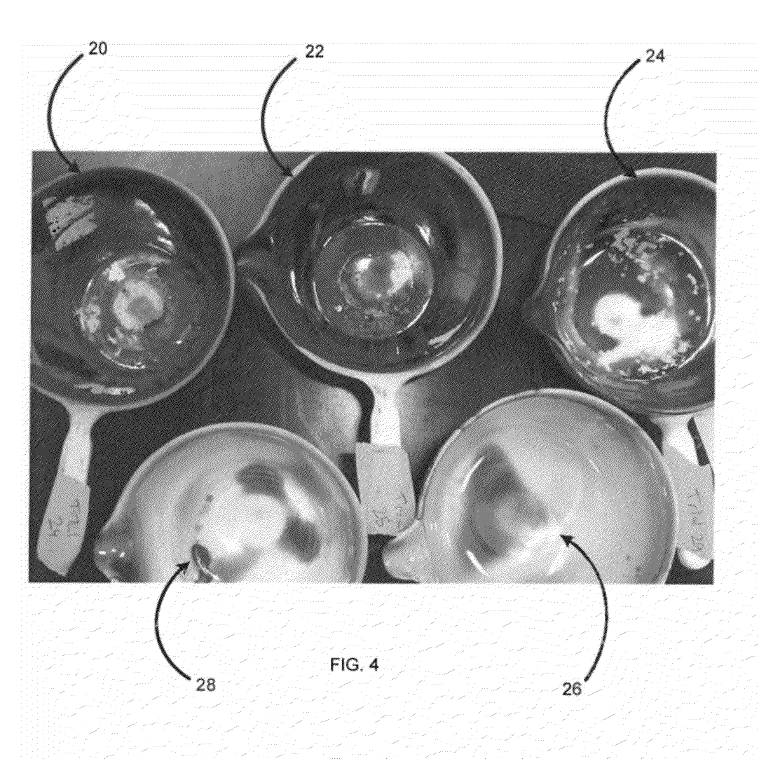

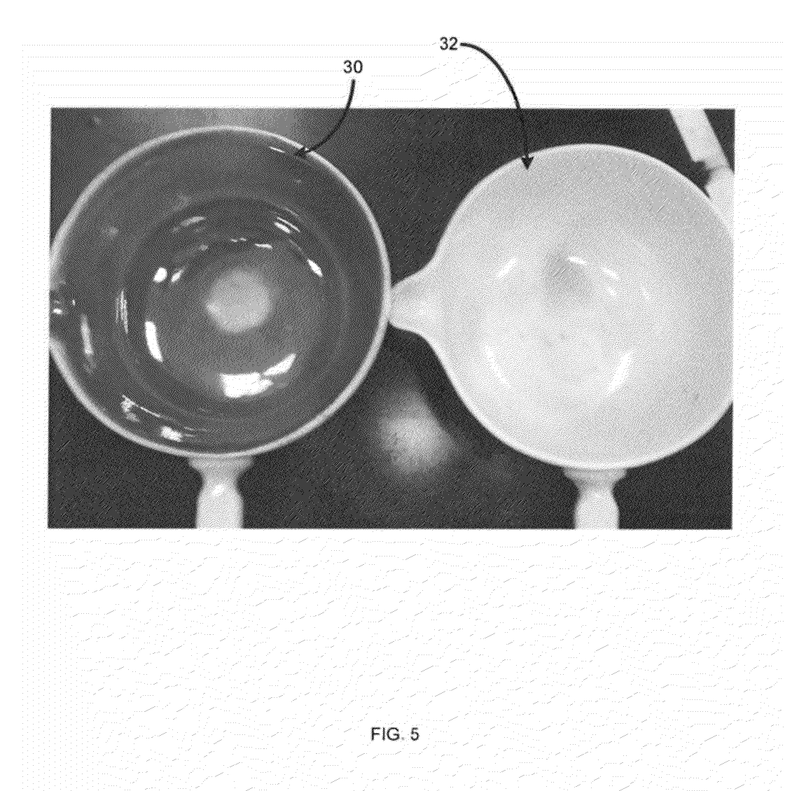

Without being limited to a theory of operation, it is currently believed that the use of sulfur promotes the formation of graphene. FIG. 1 illustrates the proposed mechanism for graphene formation. With reference to FIG. 1, it is currently believed that sulfur may cause, either catalytically or stoichiometrically, the dehydration and/or dehydrogenation and crosslinking of the starting material at particular temperature ranges. In a particular disclosed embodiment, it is currently believed that sulfur reacts with the starting material, either an aliphatic compound or a hydroxyl-containing compound (e.g. an alcohol), to dehydrate or dehydrogenate the starting material to produce an alkene moiety. The sulfur can then react with the alkene to form polysulfide linkages, linking multiple alkene-containing moieties. Subsequent degradation and rearrangement then produces the desired grapheme product. Particular embodiments illustrate that increasing amounts of sulfur will contribute to increased amounts of graphene. Embodiments that do not employ the addition of sulfur or carbonaceous materials comprising sulfur do not result in detectable formation of graphene. A person of ordinary skill in the art will recognize that the amount of sulfur added depends on whether the sulfur is used catalytically or stoichiometrically. For example, graphene can be produced from heating the starting material in conjunction with sulfur and/or starting material comprising sulfur, wherein the amount of sulfur ranges from greater than 0 grams of sulfur to about 10 grams of sulfur. In particular embodiments, 0 grams of sulfur did not produce graphene, whereas 0.100 grams to about 5.00 grams of sulfur produced visible formation of graphene. FIGS. 2-5 illustrate graphene formed from the use of different starting materials and varying amounts of sulfur. FIG. 2 is a digital image of the results from the current method utilizing paraffin and 3.5 grams (2), 2.0 grams (4), and 0.5 grams (6) of sulfur, all of which provided detectable amounts of graphene. FIG. 3 is a digital image of the results from the current method utilizing motor oil and 5.0 grams (10), 2.0 grams (12), 1.0 grams (14), 0.10 grams (18) of sulfur, as well as no sulfur (16). The sample without sulfur did not produce detectable formation of graphene. FIG. 4 is a digital image of the results from the current method utilizing mineral oil and with 5.0 grams (20), 2.0 grams (22), 1.0 grams (24), 0.10 grams (28) of sulfur, as well as no sulfur (26). FIG. 5 is a digital image of the results from the current method utilizing cyclohexanol and 5.0 grams sulfur (30), as well as no sulfur (32). Again, the sample with no sulfur did not produce graphene. According to all of these embodiments, decreasing amounts of sulfur resulted in decreased formation of graphene.

The sulfur may promote the direct formation of graphene, or the sulfur may promote the formation of a reaction intermediate, which serves as a precursor to the formation of graphene. In certain embodiments, the starting materials were heated in the absence of oxygen (such as by heating in a closed system), whereby the reaction intermediate can be observed, typically as a tar-like substance. Upon further heating of the system, the reaction intermediate can coat the heated surfaces of the system, particularly the outer container, and after cooling, the graphene product can be detected and/or isolated. In other embodiments, the starting materials were heated in the presence of oxygen (such as by heating in a system open to air), whereby the reaction intermediate can be observed to dissipate into the atmosphere, resulting in no graphene formation. Without being limited to a theory of operation, it is currently believed that exposure of the reaction mixture to oxygen during heating will result in oxidation of the reaction intermediate, thereby preventing the ability of the reaction intermediate to be converted to graphene.

C. Graphene Formations

Particular embodiments utilize a method for forming graphene, comprising a starting material (or plurality of starting materials), typically comprising a carbonaceous material and an independent source of sulfur, an optional graphene-coatable material, and a reaction vessel comprising a first container, an optional second container, and a cover. In other embodiments, the method comprises a starting material, comprising a carbonaceous material that inherently contains sulfur, an optional graphene-coatable material, and a reaction vessel comprising a first container, an optional second container, and a cover.

Disclosed embodiments involve adding a starting material and sulfur, or a starting material comprising sulfur, to a first container. The addition of sulfur to the carbonaceous material can occur either before heating the reaction vessel, during heating of the reaction vessel, or after heating the reaction vessel, whereby the reaction vessel is heated again subsequent to the addition of sulfur. The reaction vessel can comprise a first container, which is heated, or it can comprise a first container that is placed inside an optional second container. Systems comprising an independent first container having a starting material and sulfur, or a starting material comprising sulfur, are sufficiently covered in a manner effective to substantially prevent exposure of the starting material and/or sulfur to an oxygen-rich atmosphere during the heating process. Certain embodiments utilize a system comprising a first container (containing a starting material and sulfur, or a starting material comprising sulfur) and a second container. The first container can be placed inside the second container and this system can be heated to a temperature and for a time effective to produce graphene, as disclosed above.

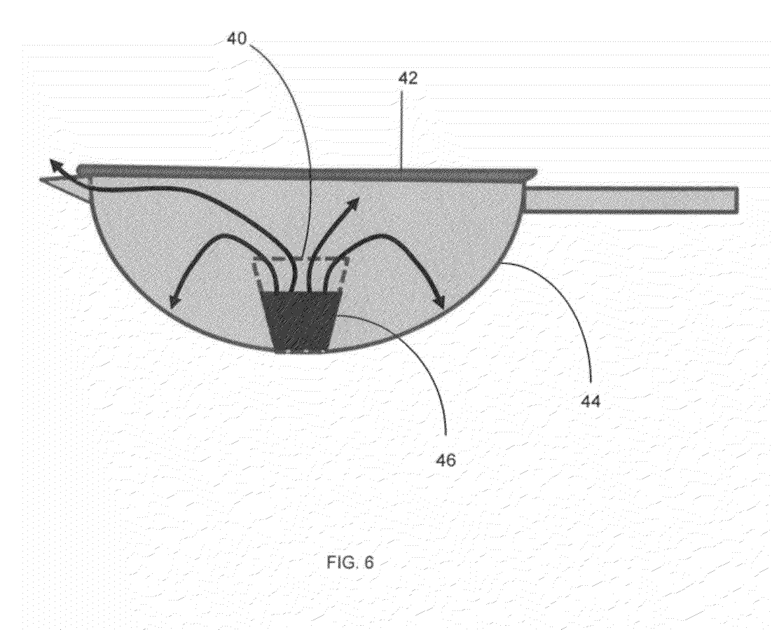

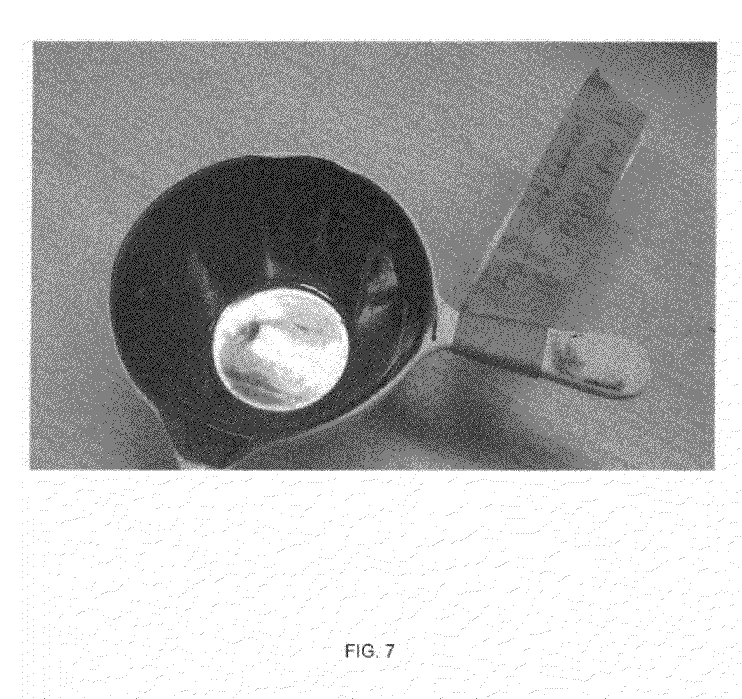

FIG. 6 illustrates a system used in working embodiments in which a first container (40), containing the combined carbonaceous material and sulfur, has been placed inside a second container (44), which is then covered with a glass cover (42). FIG. 7 is a digital image of an outer container, particularly a crucible, after the formation of graphene has occurred. A person of ordinary skill in the art will understand, based on these working embodiments, that commercial embodiments useful for producing graphene would use a system that is capable of substantially excluding oxygen.

After the system is covered, it is heated to temperatures effective to form graphene. In particular embodiments, the heat source can be an open flame or any device capable of producing temperatures effective to form graphene. A temperature effective to produce graphene can range from about 250° C. to about 1200° C.; more typically, the temperature ranges from at least about 600° C. to about 1000° C. Certain disclosed embodiments concern using temperatures ranging from about 700° C. to about 1000° C.

The reaction vessel is heated for a time effective to produce graphene. A person of ordinary skill in the art will understand that the effective time may vary depending on the amounts of carbonaceous material and sulfur. In working embodiments, the time effective to form graphene ranges from greater than 0 to about 60 minutes. Certain embodiments are heated for about 5 minutes to about 20 minutes; more typically for about 5 minutes to about 10 minutes. A person of ordinary skill in the art will understand that, in commercial embodiments, the time ranges for producing graphene may depend on the amount of starting material. In particular embodiments, vapors are produced from within the first container when heat is applied to the reaction vessel, which can be observed to condense onto the outer container and/or ignite. Once the system has been heated to a temperature and for a time effective to produce graphene, it is allowed to cool. Cooling the system can comprise affirmatively reducing the temperature of the system using cooling methods known to a person of ordinary skill in the art, or cooling the system can comprise removing the heat source from the system whereby it equilibrates to the temperature of its surrounding environment.

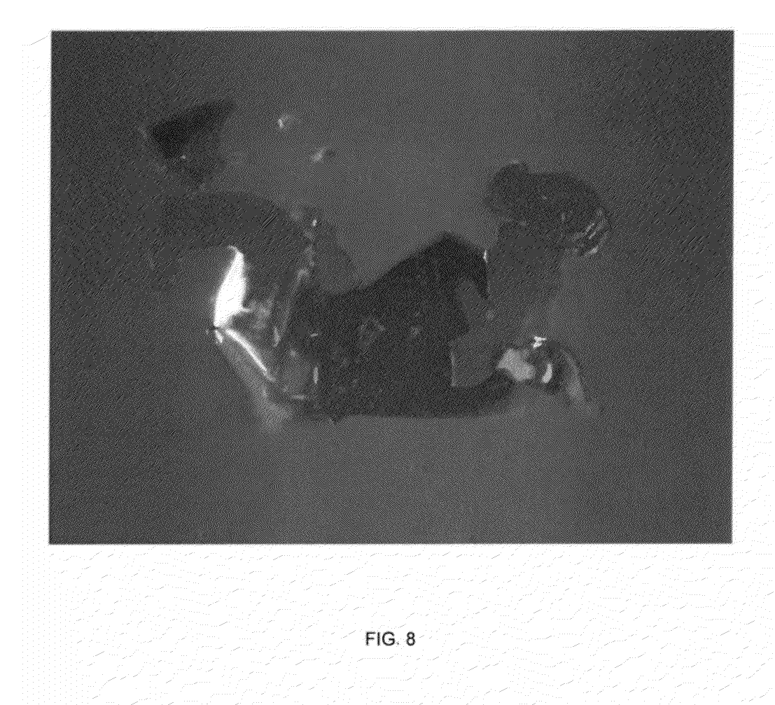

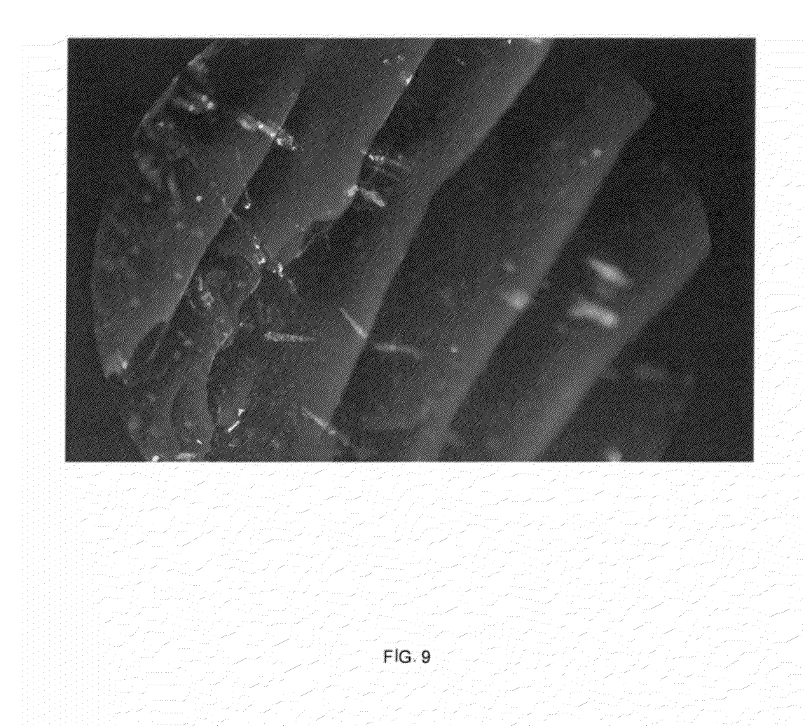

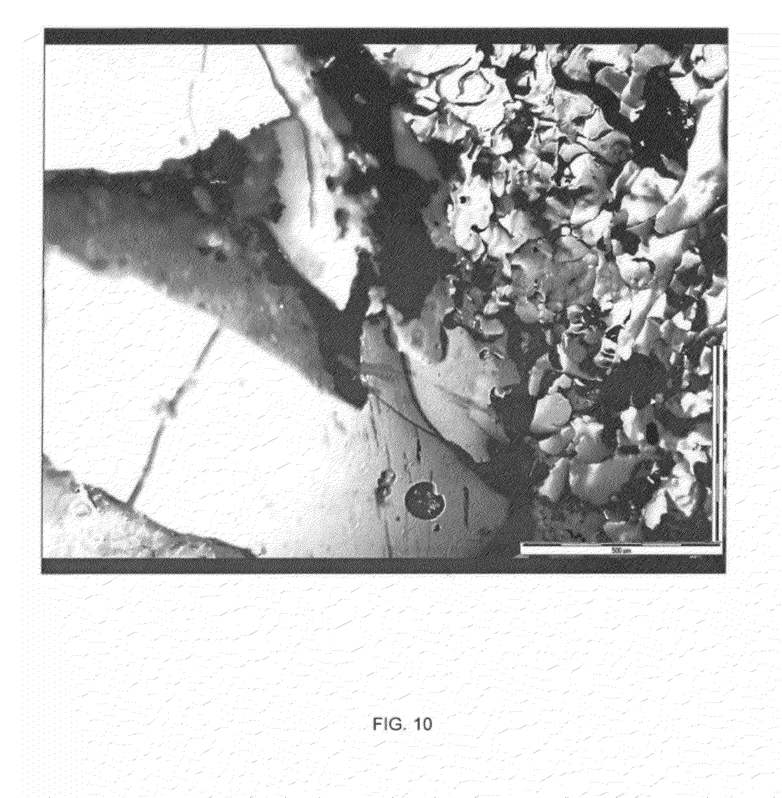

Particular embodiments produce graphene, which exhibits increased electrical conductivity and is impervious to acid, particularly sulfuric acid, perchloric acid, hydrochloric acid, and nitro-hydrochloric acid. FIGS. 8-10 illustrate exfoliated samples of graphene obtained using embodiments of the current method. FIG. 8 illustrates an exfoliated graphene sample. FIG. 9 is an image of exfoliated graphene obtained from a particular embodiment utilizing motor oil and 5.0 grams of sulfur. FIG. 10 is an image of exfoliated graphene obtained from a particular embodiment utilizing mineral oil and 3.5 grams of sulfur. Particular embodiments demonstrate the production of multilayered graphene, but a person of ordinary skill in the art will recognize that it may be possible to produce monolayered graphene utilizing the disclosed method and that the multilayered graphene can serve as a precursor to monolayered graphene.

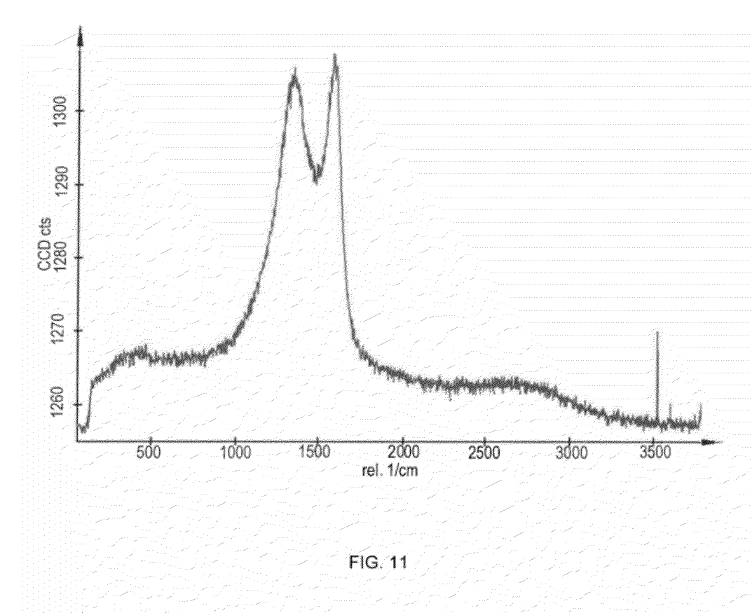

Graphene produced using the current method was analyzed using spectroscopy techniques, such as Raman spectroscopy, X-ray photoelectron spectroscopy (XPS), atomic force microscopy (AFM), scanning electron microscopy (SEM), and tunneling electron microscopy (TEM). One embodiment of the current method produced graphene having two observable and relatively broad peaks in the Raman peaks centered at 1593 cm⁻¹ and 1354 cm⁻¹ (FIG. 11). These two bands are located near to the typical G (E_{2g}) and D (A_{1g}) peaks, respectively. The G and D bands are associated with the ordered sp² carbon, and disordered, defects and edge carbons, respectively. The wavenumber positions and relative peak intensities of the D and G bands (I(D)/I(G)=0.93) indicate that the carbon in this sample is nearly all sp² in hybridization.

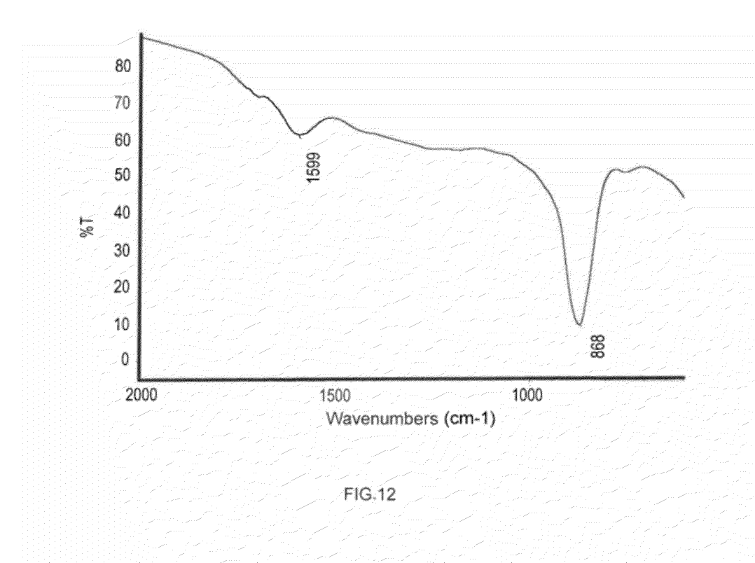

The IR analyses were conducted by depositing the graphene produced by working embodiments onto germanium. The spectrum appears in FIG. 12. Two bands appear at 868 and 1599 cm⁻¹. The position of these bands respectively matches those of the A_{IU} out of plane and E_{IU} stretch of the intralayer bonds of graphene. On the other hand, there are no peaks that match the expected positions for C—O or C═O stretches (1715-1740 and 1050 cm⁻¹). Based on the sum of the Raman and IR data, it can be concluded that the synthesized graphene is mostly carbon in the sp² form, and that oxides are not the predominate form of this particular embodiment.

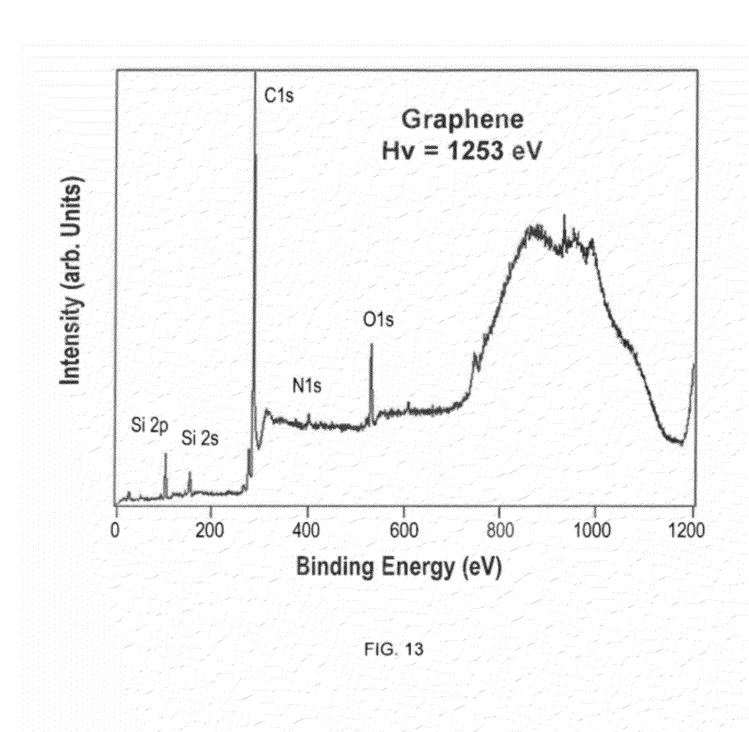

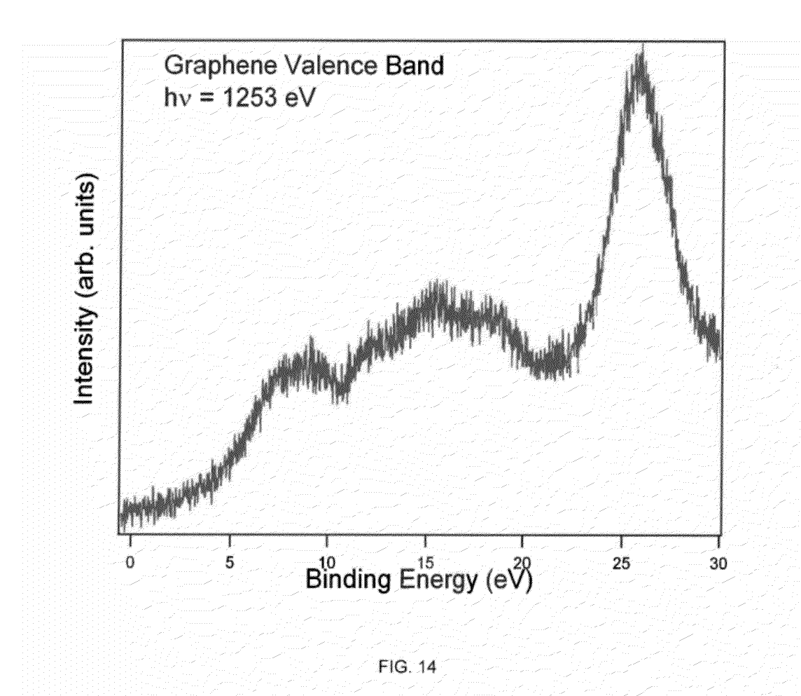

XPS can be used to determine the elemental composition of graphene produced using the current method. Wide XPS scan (FIG. 13) reveals peaks that correspond to carbon (C) is (284.2 eV); the oxygen (O) is (533.3 eV); the silicon (Si) 2p (103.7 eV); the silicon (Si) 2s (155.6 eV) and the nitrogen (N) is (401.2 eV). Given that the samples were cleaved in the air prior to insertion into the vacuum chamber, it is difficult to ascertain if the O 1s peak is due to adsorbed H₂O, CO, or CO₂. In order to resolve the origin of the O 1s peak (i.e. in situ incorporation, or ex situ adsorption) the sample was annealed to 800° C. in vacuum. No change in the binding energy or intensity of the O 1s core level state was observed, indicating that the presence of the O 1s peak is due to in situ incorporation into the graphene films. The presence of broad features between 5 eV and 20 eV in the valence band spectrum (FIG. 14) is attributed to semi-metallic graphite, as opposed to diamond where these features are much more pronounced. However, in the case of graphene, XPS of the valence band alone is not sufficient for evaluating the metallic of the samples. The large peak at 25.5 eV is unassigned. However, Schafer et al (Matter. 1996, 53, 7762) have suggested that the appearance of oxygen on the surface of graphene results when the O 2p state mixes with the graphene valence band resulting in a feature around a binding energy of 26 eV. This assignment appears to be consistent with the present study when taken in conjunction with the observation of oxygen incorporated into the graphene film.

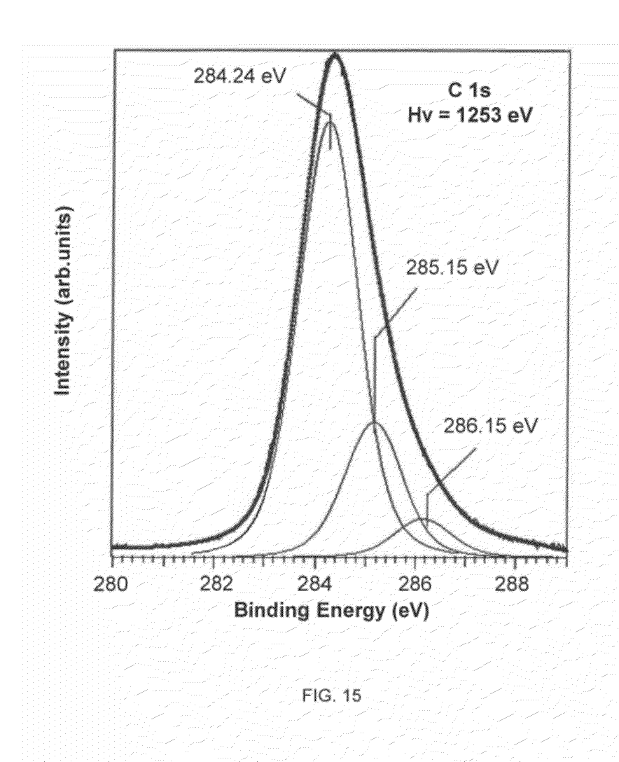

FIG. 15 illustrates three deconvolved peaks of 284.2, 285.2 and 286.2 eV. The 284.2 eV peak agrees well with literature regarding the sp² hybridized carbon-carbon bond, such as findings by Estrade-Szwarckopf (Carbon. 2004, 42, 1713), Yu et. al. (Nano Lett. 2009, 9, 1752), and Winter et. al. (Appl Surf Sci. 2000, 167, 99). The peak at 285.2 eV holds two possibilities: C—H sp³, as has been noted with graphite; or C═N sp², as has been suggested for nitrogen doped graphene and carbon nanotubes. The latter is of consideration based on the appearance of the N 1s peak (401.2 eV) in the wide scan XPS of FIG. 13. The 286.2 eV peak is associated with C—O sp³, or other forms of C═N sp². These assignments are summarized in Table 1.

TABLE 1

| XPS Peak | Possible Assignment |
|---|---|
| 284.2 eV | C═C, sp² |
| 285.2 eV | C—H sp³ or C═N sp² |
| 286.2 eV | C—OH, C—O—C, or C═N sp² |

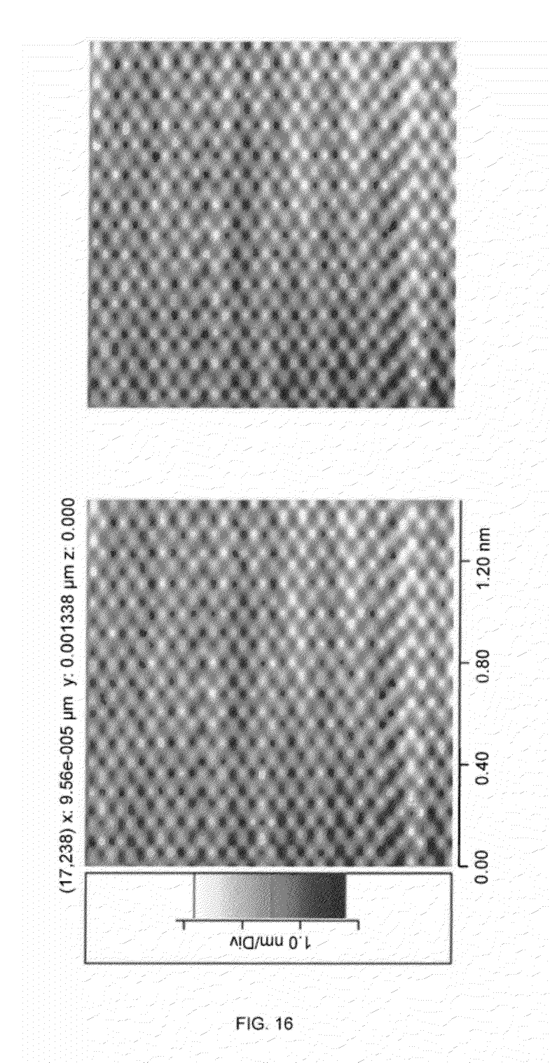

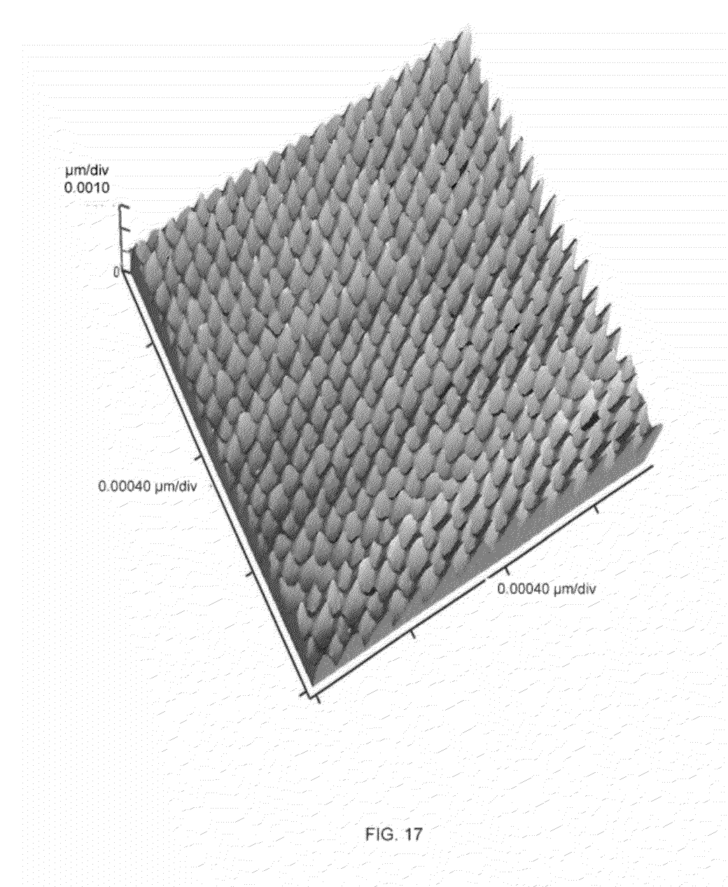

AFM can also be used to illustrate that particular embodiments of the current method produce graphene. AFM images, obtained in contact mode under ambient conditions, show the sample topography in 2 dimensions (FIG. 16) and 3 dimensions (FIG. 17). The images illustrate the expected hexagonal lattice and interatomic C—C distance (0.148 nm) of graphene. The interatomic C—C distance was obtained from line analysis (comprising a scanning area of 2.2 nm×2.2 nm and a scan speed of 15 Hz), results of which are shown in FIG. 18.

Care was taken to ensure that anomalous effects did not alter the atomic force micrographs. These effects include repulsive force associated between the tip and the sample of approximately 1-5 nN. Generally, under ambient conditions the surface is covered by one or more layers of absorbed water and other low molecular weight airborne contaminants leading to substantial capillary forces pulling the probe towards the sample with pressures of the order of GPa. Also, there is often an appearance of atomic structure without attaining true atomic resolution for materials of planar anisotropy such as HOPG and mica, where the molecular layers are known to translocate in a corrugated fashion moving in registry with the AFM tip. Imaging can further be complicated by the electrostatic forces between the tip and sample. Atomic repeat structures in the graphene layer were obtained by minimizing the tip force with a softer probe of high resonant frequency operating at a low setpoint. As the analysis was performed in air, the image is dominated by the topmost atomic layers.

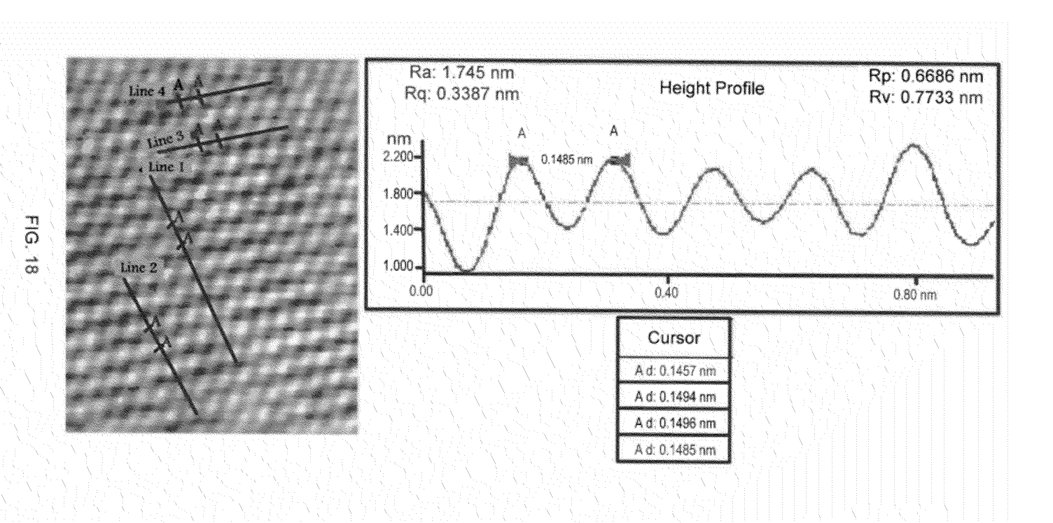

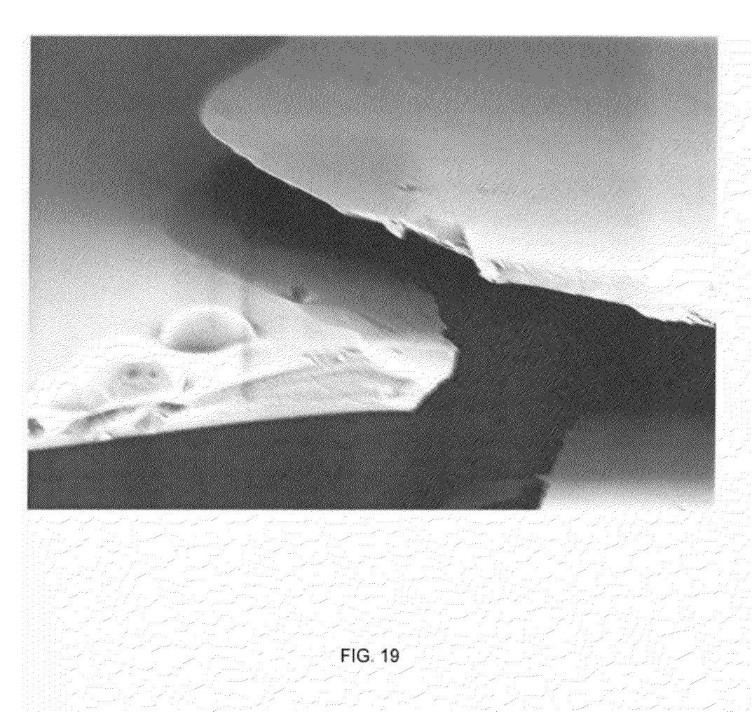

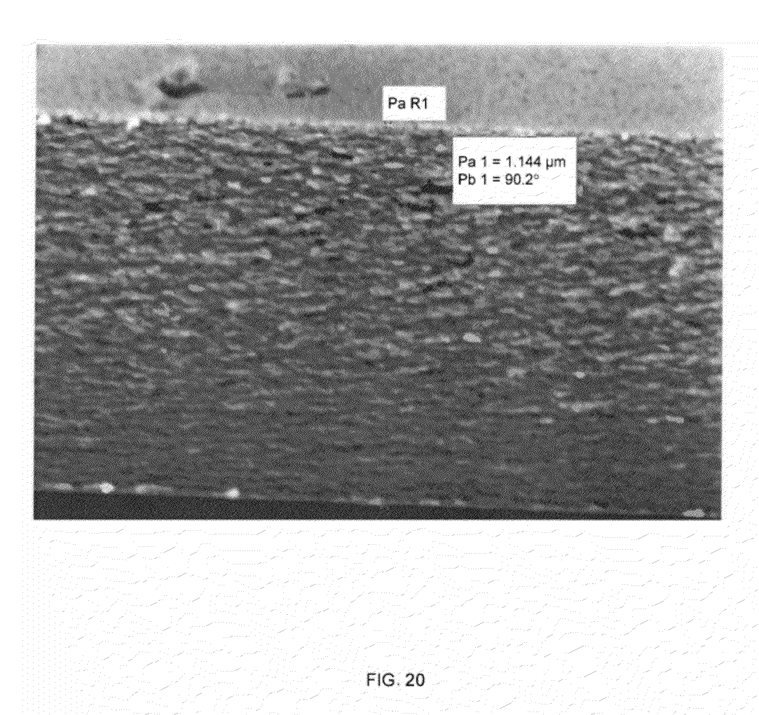

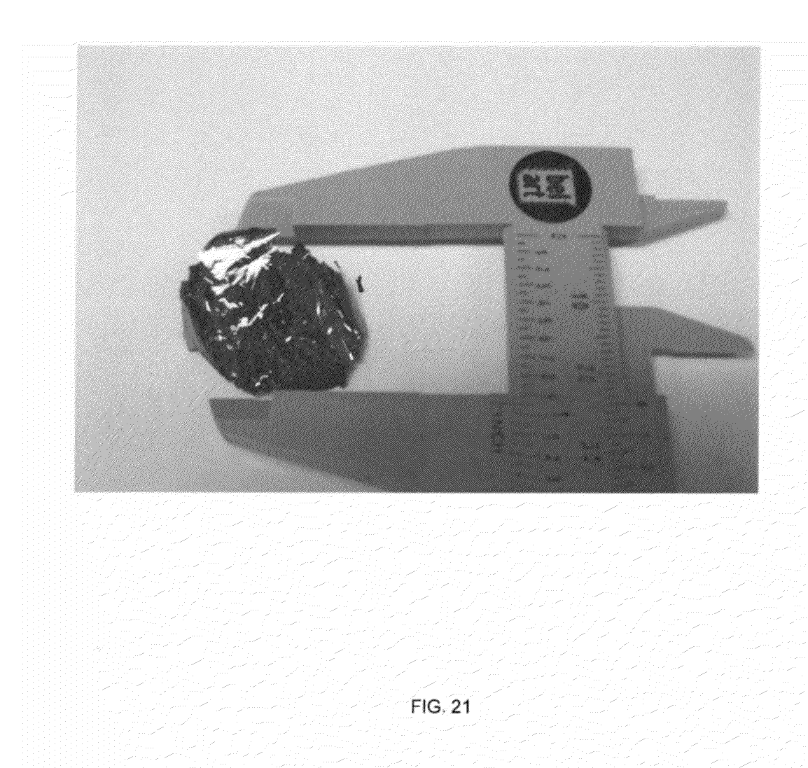

FIG. 19 is a SEM image of graphene flakes obtained using particular embodiments of the current method. FIG. 20 is a SEM image of the edge of a graphene sample produced by working embodiments, illustrating its layered characteristics. A particular embodiment of a graphene flake produced using the current method, and its relative size, is illustrated in FIG. 21.

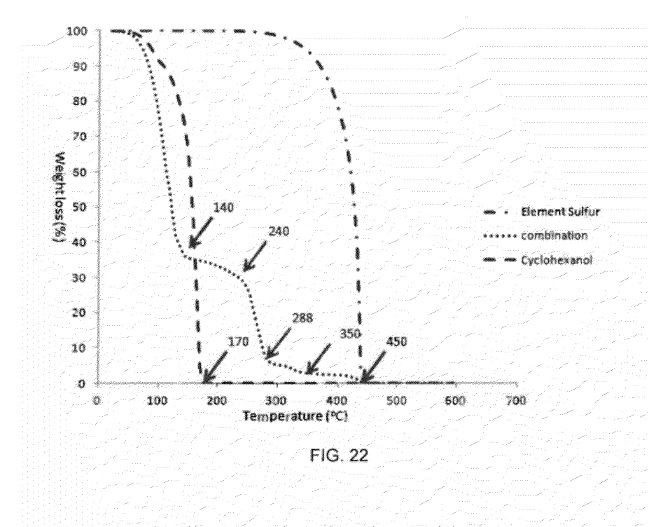

In other disclosed embodiments, thermo gravimetric analysis (TGA) may be used to determine the minimum temperature for graphene formation as well as detect possible reaction intermediates. In particular disclosed embodiments, TGA was carried out by starting the reaction at room temperature, and providing a temperature increase of approximately 10° C. per minute to a temperature maximum of approximately 800° C.; more typically about 700° C.; even more typically about 600° C. Particular substances, such as unreacted starting materials, typically evaporate at the boiling point of the substance. FIG. 22 is a TGA thermogram, which illustrates a particular disclosed embodiment wherein cyclohexanol, elemental sulfur, and a combination thereof is exposed to the disclosed temperature treatment. According to FIG. 22, the temperature at which each material is lost may be determined, and particular inflection points may result, which can indicate a sequence of reactions that occur during the process.

### IV. Methods for Using Graphene

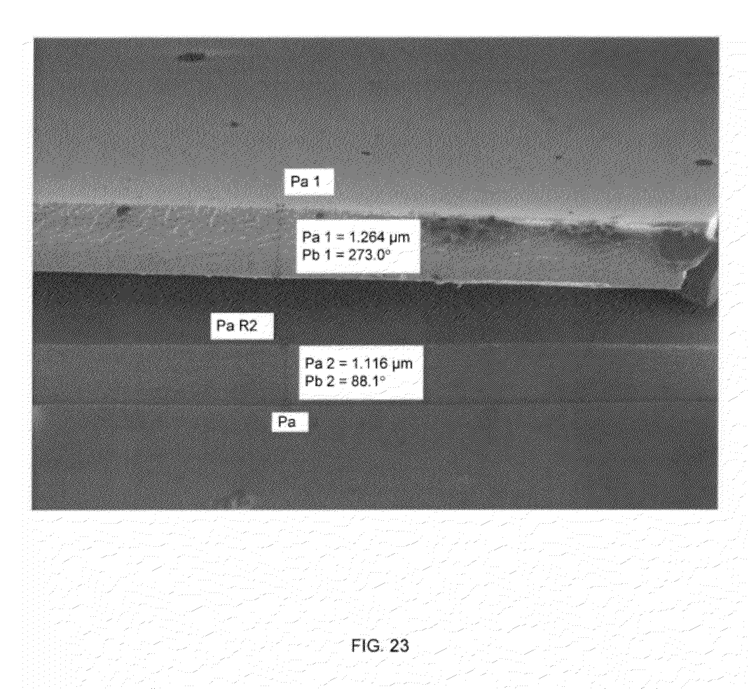

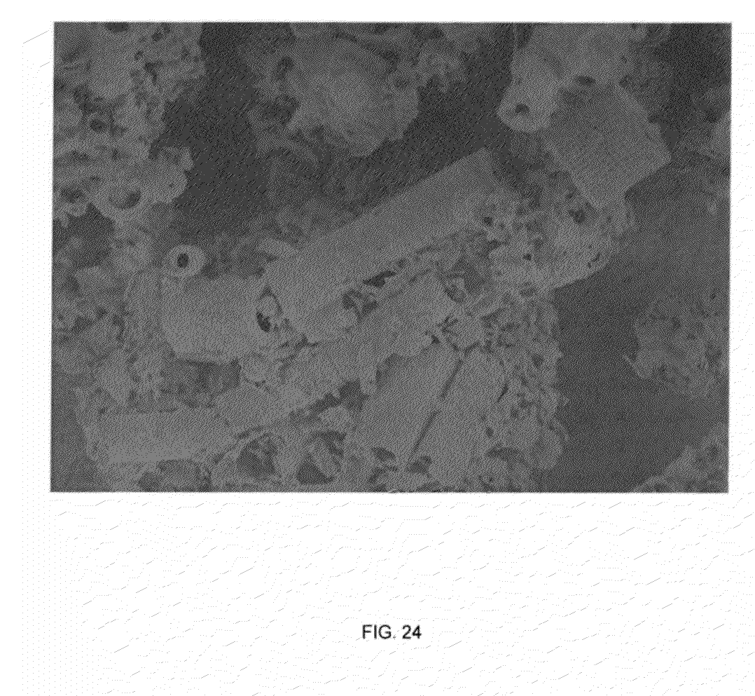

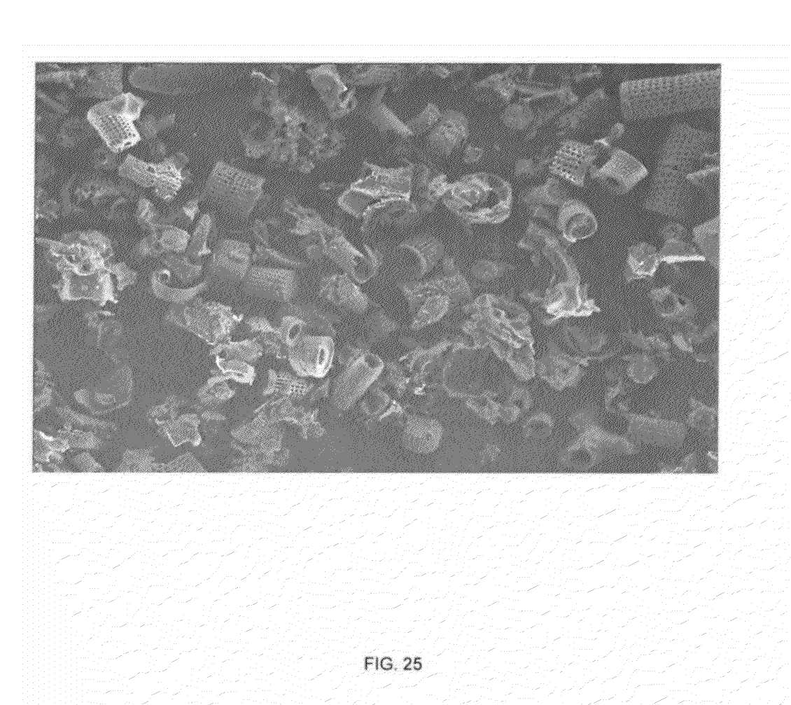

Some embodiments utilize the disclosed method to at least partially or fully coat particular materials or devices having coatable surfaces. Particular embodiments provide the ability to cover these materials in situ. For example, a coatable material (such as, but not limited to, nanotubes, diatoms, copper, iron, glass, silicon, and aluminum) is placed in the second container, proximal to the first container. The reaction vessel is then closed to the surrounding oxygen-rich atmosphere. Upon heating, the starting material and sulfur in the first container can react to form vapors. These vapors can then condense within the outer container where the graphene-coatable materials are located. Condensation of the vapors within the outer container will ultimately deposit graphene on the graphene-coatable materials either before or upon cooling of the system to room temperature. Cooling the system can comprise affirmatively reducing the temperature of the system using cooling methods known to a person of ordinary skill in the art, or cooling the system can comprise removing the heat source from the system whereby it equilibrates to the temperature of its surrounding environment. FIGS. 23 and 24 illustrate various graphene-coatable materials that were covered with graphene formed from roofing tar. FIG. 23 illustrates an image of a silicon wafer that has been coated in graphene, using the disclosed method. FIG. 24 illustrates diatoms coated in graphene, whereas FIG. 25 illustrates uncoated diatoms.

Embodiments of the current method can produce graphene for use as an electronically conducting and/or semiconducting material in applications, such as solar energy conversion, transparent electronics and electrodes, light emitting diodes, flexible displays, and chemical sensors.

### V. Examples

The following examples are provided to exemplify certain features of working embodiments. A person of ordinary skill in the art will appreciate that the scope of the present invention is not limited to the working features of such examples.

### Chemicals:

Starting materials consisted of various ratios elemental sulfur (99.5% Alfa Aesar, Ward Hill, Ma). Organic starting materials include cyclohexanol (99% Aldrich, Milwaukee, Wis.), thiophenol (97% Aldrich, Milwaukee, Wis.), 1-octanethiol (97% Acros Organic, NJ), ethyl alcohol (AAPER Alcohol and Chemical Co., KY), 2-propanol (99.9% Fisher Scientific, NJ), 1-hexanol (98% Acros organics, NJ), hexane (99.9% Fisher Scientific, NJ), phenol (99% Acros Organic, NJ), paraffin (J. T. Baker chemical Co. NJ), toluene (99.5% Mallinckordt Chemicals, NJ), naphthalene (Willert Home Products, USA), fluoranthene (93%, Acros Organic, NJ), anthracene (98% Aldrich Chemical Company, Inc. USA), and pyrene (98% Acros Organic, NJ). Mica sheets (Ted Pella, Redding, Calif.) were used as flat substrates for depositing UITAR graphene films.

For examples 25-28, the samples used for XPS, AFM, Raman, and SEM, TEM microscopy studies were produced using cyclohexanol and elemental sulfur. Prior to analysis, graphene samples were sonicated in toluene for 15 minutes to remove sulfur particles from the surface.

### Scanning Electron Microscopy (SEM):

All images were produced from a Zeiss Supra 35 Scanning Electron Microscope (Carl Zeiss, Germany). The samples were produced by depositing graphene onto a Si wafer followed by cleaving with a diamond glass cutter.

### X-Ray Photoelectron Spectroscopy (XPS):

X-ray photoelectron spectroscopy (XPS) was performed in a vacuum chamber with a base pressure of 1×10⁻¹⁰ Torr equipped with a Mg Kα emission line (1253 eV) and a hemispherical energy analyzer with a resolution of 0.025 eV. The samples were cleaved using cellophane tape prior to insertion into the vacuum chamber. During spectral acquisition the samples were grounded and exposed to a 500 eV electron beam to eliminate spurious charging. All spectra were acquired at room temperature.

### Raman Spectroscopy:

The scanning confocal Raman microscope system was a WITec Alpha300 (WITec Instruments Corp., Ulm, Germany). The laser excitation wavelength was 532 nm and the optical magnification at the objective was 20×, producing a spot size of roughly 2.5 μm in diameter. Spectral scans were taken at 1-s integration times with 60 averaged accumulations with a pixel resolution of approximately 2.4 cm⁻¹ for the wide scans. Post-acquisition data processing provides better than 1 cm⁻¹ discrimination, or effective resolution. Various incident power settings up to roughly 25 mW were used with no instability or transient effects observed in the spectra. Multiple locations across multiple samples were analyzed.

### IR Spectroscopy:

A graphene film was deposited onto a 1.2 cm Ge disk (99.999%, 4 mm thick) (Lattice Materials LLC, Bozeman, Mont.) as above. Infrared spectra were taken in transmission with 4 cm⁻¹ resolution and 128 scans on a Nicolet Magna-IR 760 E.S.P. (Nicolet Instrument Corp., Madison, Wis., USA) spectrometer equipped with DTGS KBr detector.

### Atomic Force Microscopy:

The atomic scale structure of graphene was obtained using a Veeco di CP-II atomic force microscope (AFM) operating in contact mode in air at room temperature. The AFM was operated in low-voltage mode to minimize electronic noise with a contact force (between cantilever and sample) of approximately 10⁻⁹ N, and a 5-μm scanner was used to obtain the images. The probes were made of non-conductive silicon nitride with a cantilever spring constant of 0.01 N/m, nominally. Before observation under AFM, the graphene samples were cleaved in air for a fresh surface free of secondary contamination. The topography images were obtained in constant-height mode where the tip-to-sample spacing was not varied, as typical where molecular or atomic accuracy is desired and at a scan rate of 15 Hz; a faster scan rate reduces the effects of thermal drift resulting in better resolution.

### Thermogravimetric Analysis (TGA):

Thermogravimetric analyses (TGA) was carried out in a TGA Q50 (TA instrument Inc, USA). Cyclohexanol (40 mg) and sulfur (1 mg) were used as the starting materials. All samples were placed in covered aluminum pans (TA Instruments) prior to TGA runs. A flow of N₂ (99.97%, Oxarc, Spokane, Wash.) was used to displace ambient atmosphere.

### Example 1

Ace Hardware plastic roof cement, which consists primarily of asphalt but included mineral spirits, clay, cellulose, and water, was used as carbon source. The diatomites commonly used for filtering swimming pools, were also obtained from Ace Hardware. The silicon wafer was obtained from University Wafer (Boston, Mass.). It was of 111 orientation with 300 nm thermal oxide, and resistivity of 0.001-0.002 ohm-cm.

The reaction vessel was a 60 mL (70 mm) Coors casserole crucible with an inner 5 mL crucible holding the starting material. The inner crucible was filled with 5 g of asphalt precursor and placed in the larger casserole crucible. A watch glass covered the top of the apparatus. The system was heated for 12-15 minutes followed by cooling for 5-10 minutes. Various target substrates were placed on the bottom of the outer crucible, including silicon wafer fragments and diatomites. A silicon wafer acted as a flat substrate for XPS, AFM, Raman, SEM, and optical microscopy studies.

### Example 2

An oil shale sample approximately 2×10 cm³ was added to a casserole crucible and then heated for 20 minutes. No combustion was observed, but the production of brown smoke was observed. After cooling for 10 minutes, graphene was observed to have formed on the sides of the crucible.

### Example 3

An effective amount of bitumen (with mineral spirits removed via evaporation) was added to a large crucible. The outer surface of the crucible, containing the sample, was heated for 15 minutes, followed by cooling for 10 minutes. Graphene was observed to have formed in the crucible.

### Example 4

An effective amount of an asphalt/bitumen mixture was placed in a small crucible. The small crucible was then placed inside a larger crucible, the outer surface of which was heated for 12 minutes, followed by cooling for 10 minutes. Graphene was obtained, and was subsequently exfoliated to provide samples necessary for analysis.

### Example 5

To a small reaction vessel was added 6.53 g of motor oil and 7.54 g of sulfur. The reaction vessel, containing the carbonaceous material and sulfur, was placed within a larger reaction vessel and heated for 5 minutes, followed by cooling for 5 minutes. Graphene was observed on the inner walls of the larger reaction vessel.

### Example 6

To a small reaction vessel was added 6.53 g of motor oil and 1.06 g of sulfur. The reaction vessel, containing the carbonaceous material and sulfur, was placed within a larger reaction vessel and heated for 5 minutes, followed by cooling for 5 minutes. Graphene was observed on the inner walls of the larger reaction vessel.

### Example 7

To a small reaction vessel was added 14.96 g of motor oil. The reaction vessel, containing the carbonaceous material, was placed within a larger reaction vessel and heated for 5 minutes. Flames were observed after 2.5 minutes of heating and ceased after 7 minutes of heating. The heat source was removed and the system was allowed to cool for 5 minutes. Graphene formation was observed, but not in a quantifiable amount.

### Example 8

To a small reaction vessel was added 5.54 g of motor oil and 2.10 g of sulfur. The reaction vessel, containing the carbonaceous material and sulfur, was placed within a larger reaction vessel and heated for 5 minutes, followed by cooling for 5 minutes. Graphene was observed on the inner walls of the larger reaction vessel.

### Example 9

To a small reaction vessel was added 5.60 g of motor oil. The reaction vessel, containing the carbonaceous material, was placed within a larger reaction vessel and heated and cooled in a manner similar to that of Example 8. Graphene was observed on the inner walls of the larger reaction vessel.

### Example 10

To a small reaction vessel was added 6.0 g of paraffin and 3.5 g of sulfur. The reaction vessel, containing the carbonaceous material and sulfur, was placed within a larger reaction vessel and heated, followed by subsequent cooling in a manner similar to that of Example 8. Graphene was observed on the bottom of the larger reaction vessel.

### Example 11

To a small reaction vessel was added 6.0 g of paraffin and 2.0 g of sulfur. The reaction vessel, containing the carbonaceous material and sulfur, was placed within a larger reaction vessel and heated, followed by subsequent cooling in a manner similar to that of Example 8. Graphene was observed on the bottom of the larger reaction vessel.

### Example 12

To a small reaction vessel was added 6.0 g of paraffin and 0.5 g of sulfur. The reaction vessel, containing the carbonaceous material and sulfur, was placed within a larger reaction vessel and heated, followed by subsequent cooling in a manner similar to that of Example 8. Graphene was observed on the bottom of the larger reaction vessel, but not in amounts equivalent to Examples 10 and 11.

### Example 13

To a small reaction vessel was added 6.0 g of motor oil and 5.0 g of sulfur. The reaction vessel, containing the carbonaceous material and sulfur, was placed within a larger reaction vessel and heated, followed by subsequent cooling in a manner similar to that of Example 8. Graphene was observed on the bottom of the larger reaction vessel.

### Example 14

To a small reaction vessel was added 6.0 g of motor oil and 2.0 g of sulfur. The reaction vessel, containing the carbonaceous material and sulfur, was placed within a larger reaction vessel and heated, followed by subsequent cooling in a manner similar to that of Example 8. Graphene was observed on the bottom of the larger reaction vessel.

### Example 15

To a small reaction vessel was added 6.0 g of motor oil and 1.0 g of sulfur. The reaction vessel, containing the carbonaceous material and sulfur, was placed within a larger reaction vessel and heated, followed by subsequent cooling in a manner similar to that of Example 8. Graphene was observed on the bottom of the larger reaction vessel.

### Example 16

To a small reaction vessel was added 6.0 g of motor oil and 0.1 g of sulfur. The reaction vessel, containing the carbonaceous material and sulfur, was placed within a larger reaction vessel and heated, followed by subsequent cooling in a manner similar to that of Example 8. Graphene was observed on the bottom of the larger reaction vessel.

### Example 17

To a small reaction vessel was added 6.0 g of motor oil. The reaction vessel, containing the carbonaceous material, was placed within a larger reaction vessel and heated, followed by subsequent cooling in a manner similar to that of Example 8. Graphene formation was not observed.

### Example 18

To a small reaction vessel was added 6.0 g of mineral oil and 5.0 g of sulfur. The reaction vessel, containing the carbonaceous material and sulfur, was placed within a larger reaction vessel and heated, followed by subsequent cooling in a manner similar to that of Example 8. Graphene was observed on the bottom of the larger reaction vessel.

### Example 19

To a small reaction vessel was added 6.0 g of mineral oil and 2.0 g of sulfur.

The reaction vessel, containing the carbonaceous material and sulfur, was placed within a larger reaction vessel and heated, followed by subsequent cooling in a manner similar to that of Example 8. Graphene was observed on the bottom of the larger reaction vessel.

### Example 20

To a small reaction vessel was added 6.0 g of mineral oil and 1.0 g of sulfur. The reaction vessel, containing the carbonaceous material and sulfur, was placed within a larger reaction vessel and heated, followed by subsequent cooling in a manner similar to that of Example 8. Graphene was observed on the bottom of the larger reaction vessel.

### Example 21

To a small reaction vessel was added 6.0 g of mineral oil and 0.1 g of sulfur. The reaction vessel, containing the carbonaceous material and sulfur, was placed within a larger reaction vessel and heated, followed by subsequent cooling in a manner similar to that of Example 8. Graphene was observed on the bottom of the larger reaction vessel.

### Example 22

To a small reaction vessel was added 6.0 g of mineral oil. The reaction vessel, containing the carbonaceous material, was placed within a larger reaction vessel and heated, followed by subsequent cooling in a manner similar to that of Example 8. Graphene formation was not observed.

### Example 23

To a small reaction vessel was added 6.0 g of cyclohexanol and 5.0 g of sulfur. The reaction vessel, containing the carbonaceous material and sulfur, was placed within a larger reaction vessel and heated, followed by subsequent cooling in a manner similar to that of Example 8. Light graphene formation was observed on the bottom of the larger reaction vessel.

### Example 24

To a small reaction vessel was added 6.0 g of mineral oil. The reaction vessel, containing the carbonaceous material, was placed within a larger reaction vessel and heated, followed by subsequent cooling in a manner similar to that of Example 8. Graphene formation was not observed.

### Example 25

A composition comprising cyclohexanol (20 mg) and sulfur (approx. 1 mg) was added to a thermogravimetric oven. The system was reacted under an inert atmosphere of nitrogen gas. The system was heated and cooled in a manner and for a time similar to the previous examples. Graphene formation was observed.

### Example 26

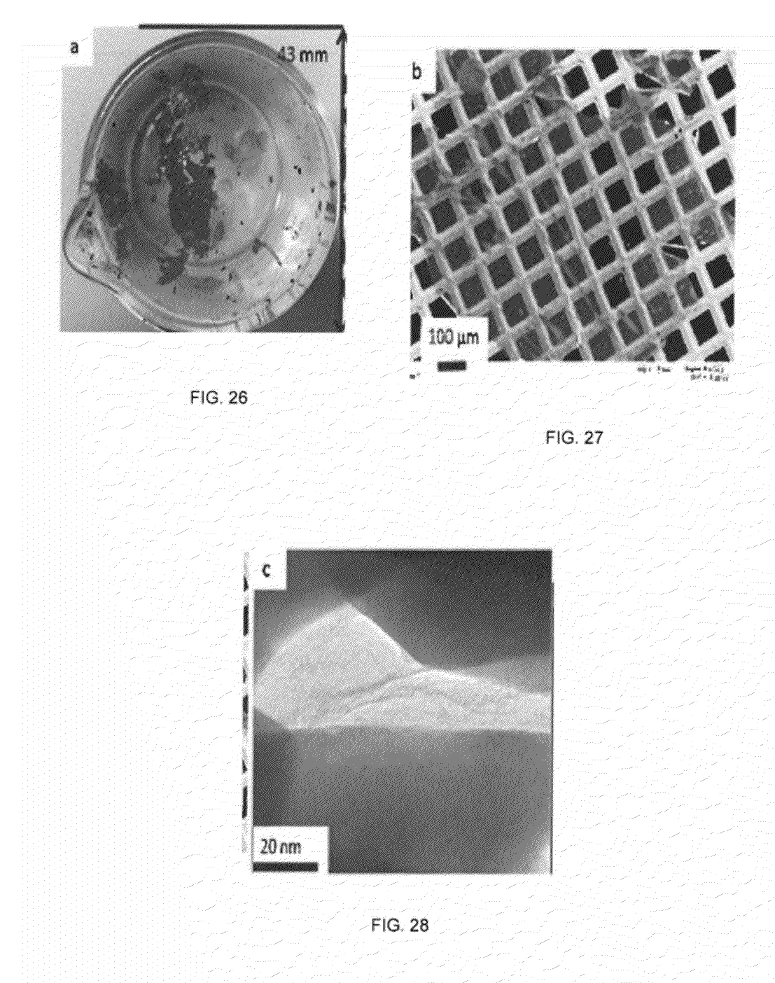

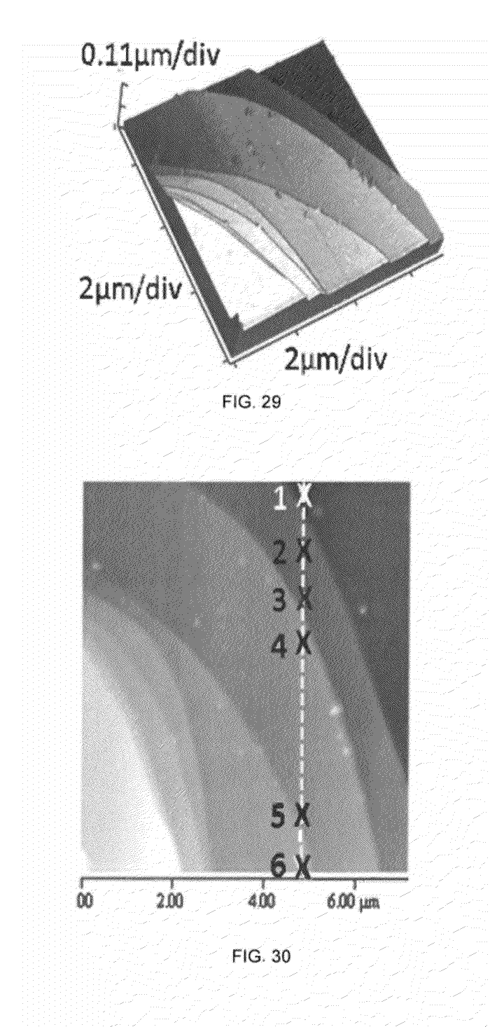

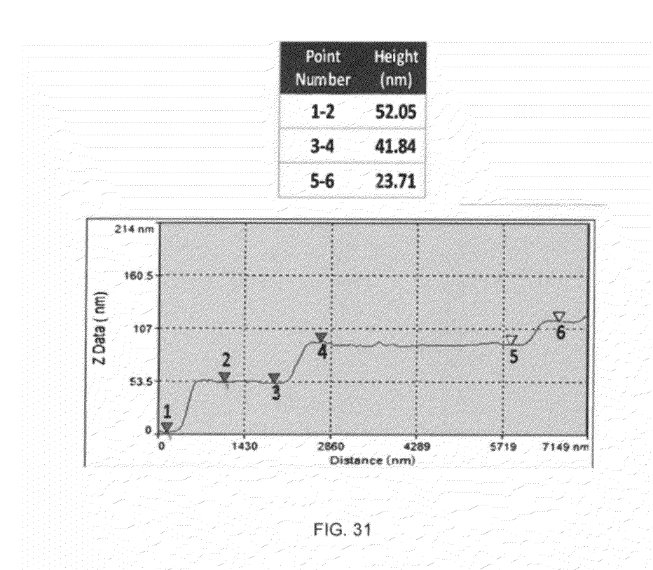

Multilayer graphene was prepared with cyclohexanol and sulfur starting reagents through the disclosed method using either a flame-initiated apparatus or a thermo gravimetric apparatus (TGA). Graphene formation was observed using morphological, XPS and Raman evidence (FIGS. 26-31). The proposed mechanism of graphene formation was developed by interpreting the TGA thermogram in FIG. 22. As illustrated in FIG. 1, it is proposed that there is a reaction between sulfur and cyclohexanol, as evident in the thermogram in FIG. 22. The initial loss of mass of cyclohexanol in the presence of sulfur between room temperature and 140° C. can be attributed to evaporation; however, mass stabilizes between 140 and 240° C. Between these limits, a series of reactions are possible, which are illustrated in FIG. 1. Sulfur is known to dehydrate organics, for example, cyclohexanol to cyclohexene in Step 1, as well as dehydrogenate alkanes to olefins. Sulfur then reacts with cyclohexene forming bridging polysulfide linkages followed by degradation to a monosulfide (Steps 2-3). The faster initial loss of mass in the cyclohexanol/sulfur mixture, as opposed to the cyclohexanol-only control, can be attributed to the formation of the more volatile cyclohexene (boiling point 83° C.). Past 240° C., a sequence of dehydrogenation steps continue to 400° C. At approximately that temperature, the 1450 cm⁻¹ intermediate forms, where subsequent dehydrogenation produces H₂S and multilayer graphene. The mass loss is nearly complete as this is a low yield reaction. Presumably the nonvolatile components rearrange to form graphene at a temperature between 400-600° C.

### Example 27

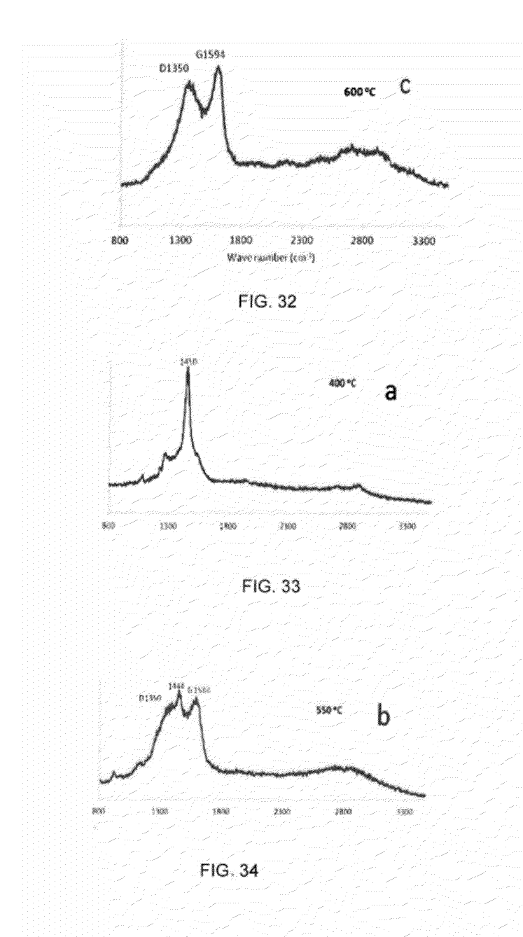

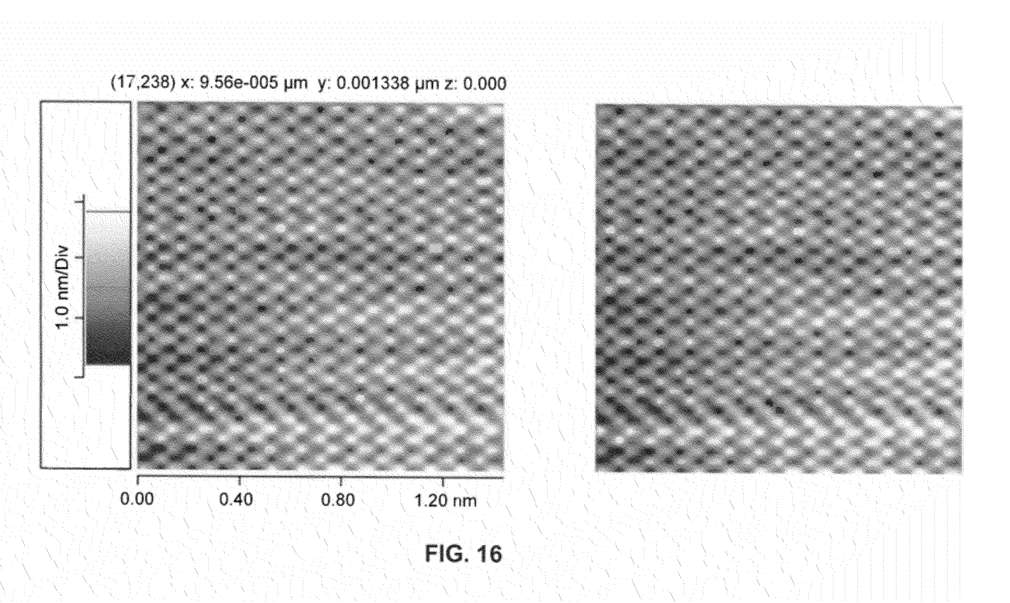

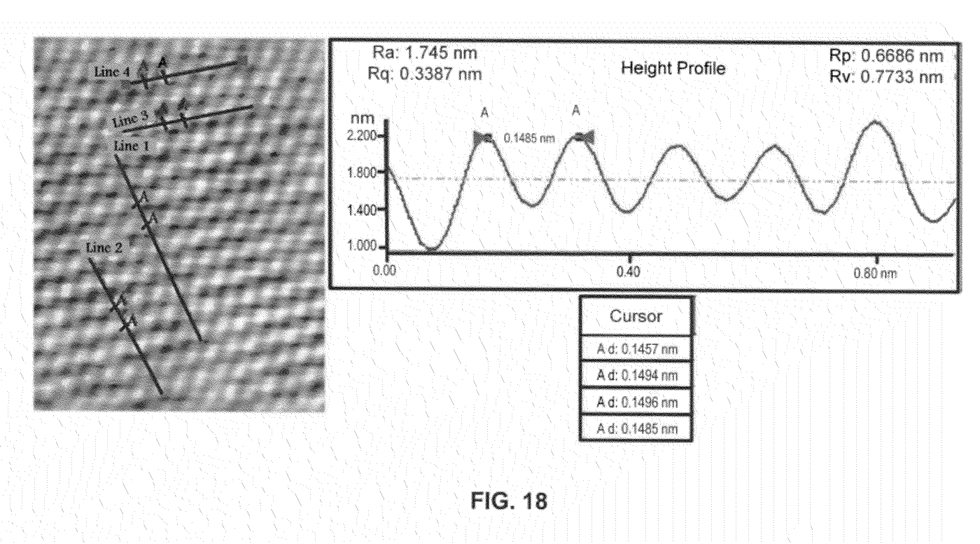

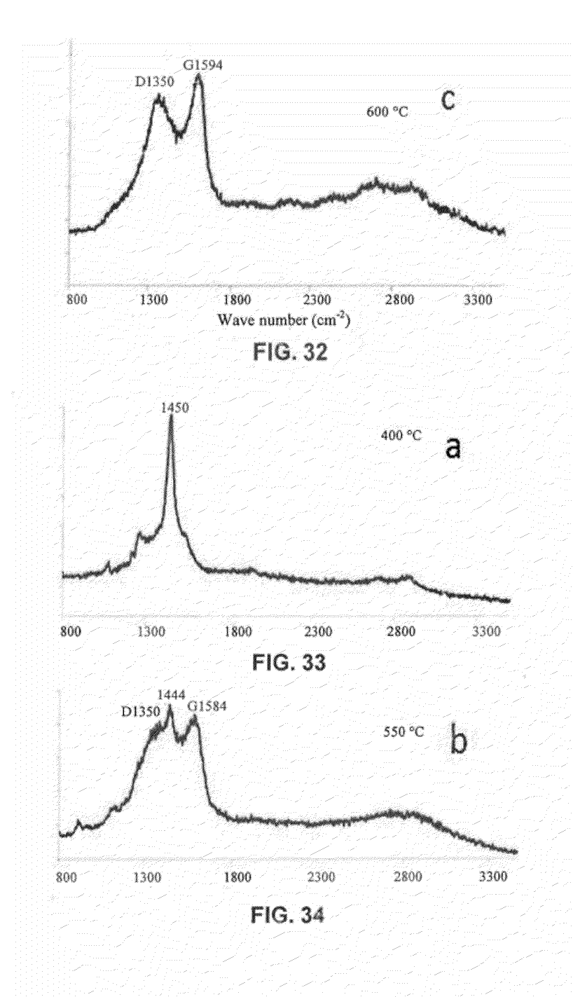

In this disclosed embodiment, TGA was performed with elemental sulfur, cyclohexanol, and a mixture of the two. The reaction was carried out starting at room temperature with a temperature with a ramp of 10° C./min to a final temperature of 600° C. Pure substances boiled away completely at their expected boiling points of 161° C. (cyclohexanol) and 444.6° C. (sulfur). When each are present the thermogravimetric curve indicates a sequence of reactions. Inflection points are separated by two broad plateaus between 140-240° C. and 288-600° C. The TGA curve drops to complete mass loss at 450° C.; however, as observed in other particular disclosed embodiments, it is a very low yield reaction. A TGA run with 40 mg of toluene and 1 mg of sulfur yielded a nearly identical curve to the one in FIG. 32.

The Raman spectra of the graphene obtained from this example, as a function of the final temperature, are shown in FIG. 32. The materials obtained either through cyclohexanol/sulfur or toluene/sulfur have the characteristic G band at 1594 (cm⁻¹) and D band at 1350 cm⁻¹ for the product obtained at 600° C. The G band arises from the first order scattering of the E_{2g} phonon of sp² carbon hybridization with the D mode associated with the disordered, defects and edge carbons in graphene. The position of these bands indicate that the material lies between crystalline to nano-crystalline, sp² carbon from the Ferrari amorphization trajectory. From FIG. 32, the I(D)/I(G) ratio is 0.97 with either starting materials. This ratio compares well with those obtained for other forms of multilayer and disordered graphenes. The Tuinstra-Koenig relationship allows for an approximation of the nano-crystal grain size based on the ratio:

$$\frac{I ( D )}{I ( G )} = \frac{C ( λ )}{{L}_{a}}$$

where C(λ) is 4.96 nm for a 532 nm excitation laser. The calculated grain size (Lₐ) is approximately 5 nm for the graphene produced from the TGA runs. This result is similar to multilayer graphene prepared by other methods.

FIGS. 33 and 34 shows the Raman spectra for the cyclohexanol/sulfur mixture with a 400° C. and 550° C. terminal temperatures, respectively. For the TGA with the 400° C. final temperature an intermediate to graphene is evident by a single sharp peak at 1450 cm⁻¹. This band was also noted for the toluene/sulfur combinations. When the TGA terminated at 550° C. (FIG. 34), the D and G Raman bands appears, along with the intermediate band observed in FIG. 33. The 1450 cm⁻¹ intermediate is not evident in FIG. 32, thus, without being limited to a single theory of operation, it is currently believed that the minimum temperature for graphene formation about 600° C.

### Example 28

The results from several disclosed embodiments are summarized in Table 2. Table 2 provides results for the qualitative visual observation of graphene formation using several disclosed starting materials.

TABLE 2
Qualitative visual observations for UITAR graphene
formation with various starting materials

| Starting | | | Boiling Point | |
|---|---|---|---|---|
| carbonaceous | Added | Melting | of Organic | Observed |
| material all | Sulfur | Point | Precursor | formation of |
| 6.0 [g] | [g] | [° C.] | [° C.] | graphene films |
| Hexane | 5.0 | −95 | 69 | ++ |
| Ethanol | 5.0 | −114 | 78 | − |
| 2-Propanol | 5.0 | −89 | 82.5 | − |
| 1-Hexanol | 5.0 | 26 | 158 | ++ |
| Cyclohexanol | 5.0 | 26 | 161 | +++ |
| Cyclohexanol | 1.0 | 26 | 161 | + |
| Cyclohexanol | 0.0 | 26 | 161 | − |
| Thiophenol | 0.0 | −15 | 169 | ++ |
| Phenol | 5.0 | 40.5 | 181.7 | ++ |
| 1-Octanethiol | 0.0 | −49 | 199 | ++ |
| Toluene | 5.0 | −93 | 110 | + |
| Naphthalene | 5.0 | 80.3 | 218 | ++ |
| Paraffin | 5.0 | 45-58 | >300 | ++ |
| Anthracene | 5.0 | 218 | 340 | − |
| Fluoranthene | 5.0 | 110 | 375 | − |
| Pyrene | 5.0 | 145-148 | 404 | − |

In view of the many possible embodiments to which the principles of the disclosed invention may be applied, it should be recognized that the disclosed embodiments only exemplify the invention and should not be taken as limiting the scope of the invention. Rather, the scope of the invention is defined by the following claims. We therefore claim as our invention all that comes within the scope and spirit of these claims.

We claim:

1. A method for making graphene, comprising:
providing a starting material, comprising a carbonaceous material comprising sulfur and essentially free of a transition metal; and
heating the starting material to a temperature and for a time effective to produce graphene.

2. The method according to claim 1 further comprising affirmatively adding an effective amount of sulfur.

3. The method according to claim 1 wherein heating the starting material comprises heating the starting material for a first period of time and a second period of time.

4. The method according to claim 2 where affirmatively adding an effective amount of sulfur can occur before heating, during heating, after heating, and combinations thereof.

5. The method according to claim 2 where the carbonaceous material is a hydrocarbon.

6. The method according to claim 2 where the carbonaceous material is a heteroaliphatic or heteroaromatic compound.

7. The method according to claim 2 where the heteroaliphatic or heteroaromatic compound comprises an alcohol.

8. The method according to claim 1 where the carbonaceous material is an acyclic aliphatic compound having from about 8 carbon atoms to about 40 carbon atoms.

9. The method according to claim 1 where the carbonaceous material is a cyclic aliphatic compound having from about 3 carbon atoms to about 12 carbon atoms in a ring.

10. The method according to claim 1 where the carbonaceous material is selected from paraffin, motor oil, mineral oil, and organic compounds.

11. The method according to claim 1 where the carbonaceous material is selected from hexanes, cyclohexanol, ethyl alcohol, propanol, hexanol, phenol, toluene, fluoranthene, pyrene, naphthalene, anthracene, tetracene, pentacene, phenanthrene, and triphenylene.

12. The method according to claim 1 where the starting material comprises a carbonaceous material comprising sulfur.

13. The method according to claim 12 where the carbonaceous material comprising sulfur is a tar.

14. The method according to claim 13 where the tar is selected from asphalt, roofing tar, bitumen, and kerogen.

15. The method according to claim 1 where the carbonaceous material is a carbohydrate.

16. The method according to claim 1 where sulfur comprises a sulfur-containing material, elemental sulfur, and combinations thereof.

17. The method according to claim 16 where the sulfur-containing material is selected from thiols, sulfides, disulfides, sulfones, and sulfonyls.

18. The method according to claim 16 where the sulfur-containing material is selected from dimethylsulfoxide, thiophenol, octanethiol, and sulfosalicylic acid.

19. The method according to claim 1 wherein the temperature effective to produce graphene ranges from about 250° C. to about 1200° C.

20. The method according to claim 1 where the temperature effective to produce graphene ranges from at least about 600° C. to about 1000° C.

21. The method according to claim 1 where the temperature effective to produce graphene ranges from about 700° C. to about 1000° C.

22. The method according to claim 1 where the time effective to produce graphene ranges from greater than 0 to about 60 minutes.

23. The method according to claim 1 where the time effective to produce graphene ranges from about 4 minutes to about 20 minutes.

24. A method for making graphene, comprising heating oil shale to a temperature and for a time effective to produce graphene.

25. A method for making graphene, comprising:
providing a starting material selected from paraffin, motor oil, mineral oil, hexanes, cyclohexanol, ethyl alcohol, propanol, hexanol, phenol, toluene, fluoranthene, pyrene, naphthalene, anthracene, tetracene, pentacene, phenanthrene, triphenylene, asphalt, roofing tar, bitumen, kerogan, and/or carbohydrates; and
heating the starting material for about 4 minutes to about 60 minutes to a temperature ranging from about 250° C. to about 1200° C.

26. The method according to claim 1 further comprising a composition where the starting material consists essentially of a carbonaceous material and sulfur.

27. A method for coating a graphene-coatable material, comprising:
providing a graphene-coatable material; and
heating a carbonaceous material comprising sulfur, and essentially free of a transition metal, to a temperature and for a time effective to produce graphene in the presence of the graphene-coatable material.

28. The method according to claim 27 where the graphene-coatable surface is selected from nanosprings, nanotubes, diatomites, a metal, glass, mica, germanium, and silicon.

29. The method according to claim 28 where the metal is selected from copper and iron.

30. Graphene produced by the method of claim 1.

31. A graphene-coated product produced by the method of claim 27.
